(19) United States
(12) Patent Application Publication
(10) Pub. No.: US 2016/0086680 A1
(43) Pub. Date: Mar. 24, 2016

(54) Positron Systems for Energy Storage, Production and Generation

(71) Applicant: Aaron Gershon Filler, Santa Monica, CA (US)

(72) Inventor: Aaron Gershon Filler, Santa Monica, CA (US)

(21) Appl. No.: 14/804,323

(22) Filed: Jul. 20, 2015

Related U.S. Application Data
(60) Provisional application No. 62/026,707, filed on Jul. 21, 2014.
(60) Provisional application No. 62/034,713, filed on Aug. 7, 2014.
(60) Provisional application No. 62/044,395, filed on Sep. 1, 2014.
(60) Provisional application No. 62/050,761, filed on Sep. 16, 2014.

(51) Int. Cl. G21B 1/11

(52) U.S. Cl. CPC G21B 1/11

(57) ABSTRACT

A positron based system is disclosed which extracts electric power from matter-antimatter annihilation reactions between electrons and positrons. In one embodiment, for storage and distribution of electric power, a solar array provides power to a cyclotron that produces the positron emitter ⁵²Manganese. The positron emitting ⁵²Mn is incorporated into spinel ferrite nanoparticles capable of suspension in an electrolyte fluid. This liquid pourable energy source is deployed to operate an internal annihilation engine, and to support a system for production of further positrons by a chain reaction pair production method. The various embodiments of this fundamental and new energy system also includes a photonic energy based mechanical piston system containing ferrofluids, an annihilator electrical circuit component and the use of positrons to produce an electron depleted material to generate a static positive electric field device for battery recharging, vehicle levitation, water desalination by deionization and ion plasma rocket engine drive.

### A. CROSS REFERENCE TO RELATED APPLICATIONS

This application claims the benefits including priority under 35 U.S.C. §119(e) to the following prior filed U.S. Provisional Applications: Ser. No. 62/026,707 filed Jul. 21, 2014; U.S. Provisional Application Ser. No. 62/034,713 filed Aug. 7, 2014; U.S. Provisional Application Ser. No. 62/044,395 filed Sep. 1, 2014; and U.S. Provisional Application Ser. No. 62/050,761 filed Sep. 16, 2014 as all relate to this definitive non-provisional application to be filed by Jul. 20, 2015 in compliance with 37 C.F.R. 1.78 (a)(1-4), the contents of which, together with any attachments submitted with them, are incorporated in this disclosure by reference in their entirety.

### B. FIELD OF THE INVENTION

The present invention relates generally to the field of energy production, storage and amplification and more particularly to the application of positrons for providing a source of energy to perform electrical, chemical and mechanical work.

Creation of positrons from sources including solar electricity, using resulting matter-antimatter annihilation of those positrons to release a plurality of high energy photons is a sub-field. Further subfields include use of positrons or a positron step to: obtain electricity from photovoltaic cells; store electricity; make a material capable of delivery of a usable energy source in a liquid storage form; regenerate considerably more electricity than is used in formation due to the energy release effect of the incorporated matter-antimatter annihilation reactions; form positrons through a chain reaction including through pair production; produce a stable non-radioactive positive electric field source with various uses thereof through electron depletion.

### C. BACKGROUND OF THE INVENTION

This invention is in the field of electric power generation, storage and transmission however it relies on a source of power that has previously been difficult to exploit, a matter anti-matter reaction. Although a) this type of reaction is widely know in the physics laboratory and in medical imaging, and although b) there have been conceptual proposals for use of matter-antimatter reactions for generation of usable power for spacecraft and for other systems, and although c) there have been proposals for increased production of anti-matter in order to fuel energy release through matter-antimatter reactions, there has been little or no progress towards actual design of any system capable of routinely using the energy released in matter-antimatter reactions and applying this for ordinary tasks such providing electricity for lighting, desalinating water, operating an automobile or animating a robotic system.

### 1. General Issues

The completely unprecedented designs revealed in this application provide for the construction of very small electrical generation systems or motors that can be supplied by a renewable liquid fuel that carries the substance that generates the electric power by effectively transducing the energy output from the matter anti-matter reaction in several ways.

There is great interest in producing a consumable environmentally tolerable liquid energy source capable of generating electric power with high efficiency. The great attraction of the internal combustion engine and gasoline is that the fuel can be stored, transported and pumped and then rapidly flowed into a structured location for energy release and conversion to mechanical power. One purpose of the invention disclosed is to provide an internal annihilation engine analogous to and optimally replacing the need for carbon burning internal combustion engines.

Photovoltaic cells cannot generally generate energy from any light sources other than the sun without requiring some external system to pump in more energy than can be extracted. Other types of fuel conversion reactors and engines rely on generating heat and then extracting energy from heat, but these tend to be of low efficiency or tend to be difficult to use on a widely disseminated basis as with nuclear fission power. Nuclear fusion has not been adequately developed to function as a power source.

There has been considerable attention paid to the possibility of using matter anti-matter engines for rockets. The attraction of such designs is the efficiency of the matter anti-matter reaction, in which the matter involved is converted to energy according to the formula of E=mc². This does require the virtually insurmountable problem of accumulating anti-matter to use as a fuel and does pose the problem of the very high amount of energy released by each proton anti-proton or neutron anti-neutron reaction. This is why this type of reaction has been considered primarily in the context of inter-planetary engines for long distance space travel very often more in the realm of science fiction than in the realm of chemistry or engineering. The invented systems disclosed herein provides for readily accomplished routine use of matter/anti-matter energy production.

On a far more routine basis, matter anti-matter reactions are carried out on a standard commercial basis as part of Positron Emission Tomography or PET scanning. Short half-life positron emitting nuclides of oxygen or nitrogen are inserted into biological compounds. The compound is targeted to a desired area. When the positron is emitted upon nuclear decay, it travels through tissue for a number of millimeters (up to 1 cm) gradually losing energy until it participates in a matter anti-matter annihilation reaction generating two high energy (511 kiloelectron volt—“keV”) photons.

The positive charge on the positron results in an electrostatic attraction to the negatively charged electron, but the kinetic energy of the emitted positron allows the positron to evade this attraction until it loses most of its kinetic energy by various interactions with the atomic components in the medium through which it travels. Once the kinetic energy is fully exhausted—the positron is approaching its “rest energy”—it becomes subject to the electrical attraction of a nearby electron—the two approach, briefly form positronium (for about 125 picoseconds) and then a matter-antimatter annihilation reaction ensues. The rest mass of each becomes the energy of each of two photons—511 keV (kiloelectron volts). To conserve momentum, the two photons move away from each other in exactly opposite directions.

In other situations—such as in a collider—beams of positrons and electrons are directed at each other with high velocity. Focused targeting of the two beams is accomplished by various designs involving electric and magnetic fields. The annihilation in that situation may not involve any electrostatic attraction

PET imaging depends on the fact that the two photons from a rest energy annihilation travel away from each other in opposite directions at exactly 180 degrees, each having an energy of 511 keV. High energy photon detectors are triggered and when two detectors are activated within a few nanoseconds of each other, the electronics assesses this as a “coincidence” event. It is then a fact that the a line drawn between the two detectors will pass through the location at which the annihilation took place.

PET was hoped originally to be capable of producing very high resolution nuclear imaging for medical diagnosis. However, the distance of travel of the positron from the location of the disintegration event that generates it to the location of the annihilation event that destroys it and generates the photons degrades the spatial resolution since the distance of travel is a several millimeters and up to one centimeter.

The inventor has previously appreciated and has demonstrated in an actual experiment that the spatial resolution of PET imaging can be improved by about six-fold through the preparation of an SMPE (spinel-moderated positron emitter) (disclosed by the inventor in PCT-EP 91/01780, with the inventor's PET image results shown and described also in U.S. Pat. No. 6,562,318 FIG. 23a-e and 42:34, 45:65). The prototype that was reduced to practice involved precipitation of a mixed spinel crystal system made up primarily of iron and oxygen—essentially ceramic magnetite—with manganese-52 replacing some of the iron atoms in the crystal. Alternately, Rhodium-99, Iron-52, Cobalt-55 or a variety of other nuclides can be used. Using the method of manufacture disclosed by the inventor in U.S. Pat. No. 5,948,384, these SMPEs can be formed as 5 to 10 nanometer particles that are coated by a hydrophilic substance and dissolved in water. This allows for these agents to be provided in flowable liquid form, subject to concentration by microfilter. The distance of travel of a positron after emission and before annihilation is proportional to the density of the medium through which it travels. By including the nuclides in spinel crystals with a density six times greater than water, the distance of travel is reduced by six times (see FIG. 23 in U.S. Pat. No. 5,948,384). The half-life of ⁵²Mn is around six days.

That U.S. Pat. No. 5,948,384 has been overlooked by the USPTO in that it is invalidating prior art to various later “moderation” patents which do not cite to it, but that rely on dense materials to decrease the kinetic energy of a positron after disintegration and before annihilation even though the same term to describe the process “moderation” was used (see FIGS. 23 A-E and text column 4, 10-15, 24, 39, 42, 46 in U.S. Pat. No. 5,948,384 filed Jun. 7, 1995 with priority as to the positron moderation to Dec. 17, 1990—GB9027293—and granted Sep. 7, 1999). Affected issued US patents include: U.S. Pat. No. 6,818,902 Perez & Rosowsky—Positron Source and U.S. Pat. No. 7,750,325 Akers—Methods and apparatus for producing and storing positrons and protons. There is generally considerable disorder in the patent examination process in this field. For instance, a newly granted patent based on 2014/0184061 Weed & Machacek—Array structures for field-assisted positron moderation and corresponding methods, is very similar to information set forth in US 2007/0110208 Molina-Martinez—Antimatter electrical generator. Both fail to cite U.S. Pat. No. 5,948,384 with regard to its prior invention of moderation.

Another consideration in selection of an optimum positron emitting isotope is an assessment of the impact of various co-emitted radiation occurring with disintegration of the nucleus. The positron emission of ⁵²Mn occurs in 27.9% of ⁵²Mn disintegrations. It has an energy upon emission of 0.575 MeV which must be dissipated before rest annihilation with an electron that is also at rest in the frame of reference. Rest annihilation occurs if local electrostatic forces causing attraction between the individual positron and electron are to be relied on as the sole means of causing the terminal collision. However, 100% of ⁵²Mn disintegrations are accompanied by emission of a 1.434 MeV gamma emission. Other gamma emissions include 94.5%, 0.935 MeV; 90% 1.33 MeV; 4% 1.25 MeV, and 3% 0.85 MeV. In general, this means that for every useful positron, there will likely be three gamma rays that are two to three times more energetic than the photons emitted by any electron-positron annihilation.

Because of this associated radioactivity, for general industrial, commercial and public use, this poses the problem of much greater shielding required for the disintegration gamma rays than for the positron emission or even for the annihilation photons. This patent therefore discloses methods for extracting the utility of the anti-matter reaction by means which avoid any radioactivity whatsoever in the energy utilization product to be exploited by the end user.

It is true that if the photoelectric effect and Compton effect can be used to liberate electrons and to harvest progressively lower energy re-emitted photons from these high energy gammas as well, then each disintegration can produce four times as much electricity as a pure positron emitter. However, use of ⁹⁹Rhodium in the positron emitting ferrite is more convenient because it has no gamma emission. The positron itself is emitted at an energy of 1.03 MeV, but this is not a radiation shielding issue in the devices contemplated because a positron is a beta particle that is easily stopped by minimal shielding and can travel only very small distances. Therefore the advantage of ⁹⁹Rhodium—which has a half life of 16.0 days—is that engineering designs are less strenuous.

To improve the safety of use of this type of energy source in general commercial and public applications, it is important that the positron emitting portions of the device are always limited in their approach distance to the edges of the containment vessel. In essence there should be a layer of photoelectron and Compton electron generation that progressively extract electrons for use while diminishing or absorbing the energy of the annihilation photons. If high energy gamma rays are used, this outer shell would need to be thicker—so that although there would be more energy to work with, the amount the working volume of the engine would be reduced by the necessary shell thickness. Of note, the thickness of the shell is the same for a small or large device. Therefore if the device is a large internal annihilation engine—several feet across—then a non-emitting shell might constitute only a few percent of the total cross section of the device. However, if the device were only twelve inches wide, then most of the device would be made up of non-emitting shell. The consequence is that for large devices, it may be more efficient to use an emitter that has high energy gammas as well as positrons, but for smaller devices, a pure positron emitter would be more suitable.

Other useful positron emitting nuclides include ⁴⁴Scandium (β⁺ 78%, 1.22 MeV; g 22%, 0.373 MeV) although the half life is only 3.9 hours. ⁸⁹Zirconium is produced by cyclotron bombardment of yttrium-89 (β⁺ 22.7% 0.395 MeV; g 99%, 909 keV) and has a T_{1/2} of 3.25 days. Additionally ⁴⁸V (half life 16 days), ⁵⁶Cobalt (T_{1/2}=77 days), ⁵⁶Nickel (T_{1/2}=6 days), 55 Zinc (T_{1/2}=244 days), 87 Yttrium (T_{1/2}=3.3 days), 88 Yttrium (T_{1/2}=106 days), ⁹⁶Technetium (T_{1/2}=4.3 days), ⁹⁷Ruthenium (T_{1/2}=2.9 days), ¹⁰⁵Silver (T_{1/2}=41 days), ¹⁷⁷Tantalum (T_{1/2}=2.3 days), ¹⁹⁰Iridium (T_{1/2}=11.8 days), ¹⁹⁶Gold (T_{1/2}=6 days), ¹⁵⁰Europium (T_{1/2}=36.8 years), ¹⁵²Europium (T_{1/2}=13 years), ¹⁵⁸Terbium (T_{1/2}=180 years), ¹⁶⁹Thulium (T_{1/2}=93 days), ¹⁷⁴Lutetium (T_{1/2}=3.3 years), ²³⁰ Protactinium (T_{1/2}=17 days). Non metals include ⁸⁴Rubidium (T_{1/2}=32.7 days), ⁷⁴Arsenic (T_{1/2}=17.7 days), ²⁰⁷Bismuth (T_{1/2}=33 years), ¹²⁵Xenon (T_{1/2}=16.9 hours), and ²¹¹Radon (T_{1/2}=14.6 hours).

### 2. Complexities of the Underlying Physics of Sub-Atomic Particles

As noted above, in a rest mass situation, the annihilation of a positron through interaction with an electron results in the formation of two high energy photons at 511 keV each. The inventor now proposes to use these high energy photons to activate the flow of electric current in photovoltaic cells and other novel energy transducing combinations. For further precision it is important to consider that these events are far more complex than the summary statement at the beginning of the sentence might suggest. The annihilation process itself releases a large amount of energy, but the initial instantaneous result is a type of boson called a “Z-boson” particle.

Before proceeding with any discussion of particle physics in the context of a patent, it is important to note that conventional usage of words in particle physics is antithetical to the legal undertaking of language precision. “Z” can mean a type of boson and it also refers to the number of neutrons and protons in the nucleus.

“Color” refers to the “color charge” of quarks, anti-quarks and gluons—even using the terms red, green, and blue but totally unrelated to the use of color to refer to the effects of photon energy on the perception of visible light as various colors. To avoid these problematic ambiguities, the inventor will substitute and use the word “Z-boson” for use of Z to refer to the boson type and “Z-number” to refer to enumeration of protons in an atomic nucleus. The unfortunate use of the word color for strong interaction (gluon mediated) “charge” (which is totally unrelated to the electric charge of the hadrons and leptons) will be mitigated in this document by use of the terms “color quark charge” “red color quark charge” for these uses as they apply to quarks and gluons. Use of a color term or the word “charge” without this identifying phrase will refer to conventional electric charge. The of the word “flavor” is potentially ambiguous, but since no use of this as in human taste effects of food substances is contemplated in this document, the word “flavor” will refer to “weak interactions” that concern alterations of fermion type (leptons=electron, muon, tau; and quarks=up/down, charm/strange, top/bottom). Similarly only “up-quark” and “down-quark” will signify use of up or down as to quark characterization. A “virtual photon” refers to the transient structure formed during electron-positron annihilation as a transition form between the leptons and the resulting mesons.

Additional useful general definitions include the description of energy in electron volts (eV) wherein the energy carried by one electron in transiting a one volt potential difference is one eV, one electron at 1,000 volts is 1 keV and at a million volts is 1 MeV. Mass in particle physics is determined by e=mc² (energy=mass at the speed of light squared) so that eV can also be used to describe mass in terms of GeV/c² where in 1 GeV=10⁹ eV (a billion electron volts). In standard usage, 1 GeV=1.60×10⁻¹⁹ joules. The mass of a proton is described as 0.938 GeV/c² which is equivalent to 1.67×10⁻²⁷ kg.

With this background it can be explained that an electron and a positron—each with a rest mass of 511 keV can fuse to form a boson of much larger apparent mass. The increased mass reflects the energy released by the annihilation process. The various intermediates in the process may survive for only a billionth of a second each. The typical result is a relatively massive Z-boson with mass of 91 GeV/c² or into a virtual photon with 0 mass. The Z-boson or virtual photon then decays into a range of possible mesons which themselves then decay in a variety of possible ways. There are therefore actually thousands of different possible consequences of the positron-electron annihilation.

In some situations two B mesons (B⁰) are formed. One, B⁰, is formed from an anti-bottom quark and a down quark, while the other, anti-B⁰, is formed from an anti-down quark and a bottom quark. These B⁰ mesons each have a rest mass of 5.2 GeV/c². The energy that appears to be missing and the source of the mass involved arises in the gluons that are the mediators of the strong force—which is characterized mathematically as a second order tensor field. Additionally, the Higgs boson (126 GeV/c²) can contribute to the mass. Higgs bosons contribute to the mass of all quarks, leptons and force carrier particles (usually vector bosons) through their interaction with the Higgs field. The photon has no mass or electric charge, but has widely variable energy since it is the force carrying boson for the electromagnetic charge. It is a vector boson as opposed to the scalar Higgs boson. When a Higgs boson decays, an electron and positron are among the products, but it is not yet well understood how that process is related to the beta-decay disintegrations that are relied on to produce the positrons used in this invention.

Alternately, the Z-boson or virtual photon transitions to a charm quark and an anti-charm quark (1.3 GeV/c²). The two quarks separate, leading to progressively increasing energy in the gluon field. When the energy of the gluon field reaches a sufficient quantity, this energy is converted to new quarks—an anti-down quark to go with the charm quark and a down quark to go with the anti-charm quark. These two pairs separate further to generate two separate independent mesons a D⁻ meson and a D⁺ meson each having a mass of 1.86 GeV/c². There are numerous different decay modes for a D⁺ meson, but among these is to form a positron and an electron neutrino.

From the foregoing, it should be clear that a simple statement that a positron formed by beta decay loses energy, interacts with a low energy electron causing the two to undergo annihilation with the result of two 511 keV photons is a vast oversimplification. It is one result that can occur in certain situations. The present invention is concerned with any interaction between electrons and positrons that forms any photon, including those involving any intermediate. Relevant intermediates are those in which a positron emission with subsequent annihilation leads to emission of another positron which then ultimately leads to a photon emission. It also includes photon interactions that lead to pair production including the generation of a new positron, wherein that positron ultimately leads to photon emission. This excludes virtual photons that are merely virtual force carriers between the initial step of annihilation and the immediately resulting formation of a quark grouping of two or more quarks wherein no actual photon (not a virtual photon) results. This invention does include photons at various energies that may result and be emitted when photons emerge as a consequence of a matter-antimatter annihilation involving leptons (electrons and positrons) as well as the photons and electrons that result when such a said emitted photon deposits only a portion of its energy in subsequent interactions with particles with which it comes into approximation.

### 3. Bulk Electric Charge in Positron Formation

When a positron is released and gradually loses its initial kinetic energy of disintegration in a solid such as a metal, it then experiences strong electromagnetic repulsion from the positive charge of any nucleus, so that positrons tend to interact with outer valence electrons, free electrons in the conductive band. It is worth noting at this point that in a metal positron emitter, the nuclear charge is decreased by one in this event, so that there is now an excess electron orbiting the descendent atomic nucleus. This electron can enter the conduction band and create a negative potential in the emitter metal. If these occur in a metal with high conductance to which circuit with a voltage and load are connected, then a current can result. This is one manner in which electricity can be obtained from the process of positron emission.

### 4. Radioactivity and Radiation

One other helpful set of definitions and distinctions to be made at this point concerns the general terms “radioactivity” and “radiation.” Radiation refers to various emissions of particles—usually alpha particles including: helium nuclei, neutrons often referred to distinctly as neutron radiation; beta particles—electrons, and positrons; gamma radiation—high energy photons including X-rays, gamma rays, cosmic rays and other photon carried energy from throughout the electromagnetic spectrum. Radioactive decay is often used interchangeably with radioactivity and refers to disintegration of atomic nuclei that is generally accompanied by the emission of some sort of radiation.

Nuclear disintegration may occur with the splitting of a parent nucleus into daughter nuclides accompanied by the emission of radiation. A proton within a nucleus can undergo transmutation to a neutron by emitting a positron and a neutrino without any actual splitting of the nucleus—this will change one element into another element but one atom descends into just one subsequent atom—along with a loss of energy. Radioactive nuclides have a “half-life” that states the average time it will take for half of the atoms in a given volume to undergo disintegration Emission of radiation can also occur during fusion of nuclear components into a larger nucleus as in nuclear fusion.

Radiation can occur when an electron and positron fuse to initiate a matter-antimatter reaction even though no nucleus is involved at all. Finally, beta and gamma radiation can be produced by various energetic processes such as interaction of a photon with an electron or a nucleus, or simply as a consequence of more routine energy transfers—passage of an electric current through some types of metal filaments results in the emission of low energy photons we use as incandescent light but similar processes can emit high energy photons we call X-rays in an X-ray machine.

There is no fundamental physical difference between photons that are e.g. emitted from a filament with sufficient energy to be called X-rays as opposed to photons in emitted in the visible light range. We call the X-rays radiation both because of the potential to cause ionizations and because of the biological issue of harm to living tissue that can be caused by photons with higher energy. Thus the distinction between gamma radiation and light is defined by biology even though it can be designated as to energy and wavelength on a declarative, standardized basis. Therefore, alpha and beta emissions are radiation by the fundamental fact of their being emitted from nuclear decay, disintegration and fusion, but gamma emissions are defined as radiation based on their wavelength whatever their source.

The concept of “remanent radioactivity” is a particular aspect of this invention and is defined here to refer to the capability of a material to actively and significantly generate radiation through spontaneous nuclear decay processes. Any natural material may include a certain small percentage of radioactive material, but when the amount of such material is enhanced above background level, it may be termed to be a radioactive material.

In a system where a radioactive material such as a beta-emitting nuclide has gone through sufficient half lives as to produce an insubstantial amount of radiation—below the level of natural background radiation in sunlight or at the earth's surface in a given location—it may be said to have no remanent radioactivity. This concept is useful in a situation where, for instance, the beta emitter is used as a sort of kindling to commence a positron chain reaction—described herein below. The chain reaction could continue in non-radioactive materials so longs as a particular voltage is applied in a particular way. If the original kindling material has decayed below the level of background radiation, then the continuing positron creation events and high energy photon generation events are due to what can be termed “stimulated radiation.” If such a device is then abruptly damaged or ruptured, the radiation will cease immediately to be produced and the source or kindling radioactive source will have decayed to the point that it is no longer radioactive. The cessation of both the radioactive source based radiation and the stimulated radiation will mean that these devices have no remanent radiation when damaged and this greatly enhances their safety. This is opposite to a nuclear fission situation in which the non-productive residue remains toxically radioactive after the useful fission disintegration event. Rather, it is more similar to an X-ray machine which stops producing radiation when it is turned off.

### 5. Photoelectric Effects and the Efficiency of Photovoltaic Cells

The photoelectric effect describes a phenomenon which can occur when a photon impacts a valence electron of an atom that is part of a crystalline solid such as a metal. If the photon is in the correct frequency range (energy), then the electron will absorb that energy and emerge from the valence shell becoming a free electron—this is also termed photoionization because the atom has lost an electron. Such an electron could be ejected into a vacuum or could be ejected into the conduction band of the metal. If a voltage is applied across the solid and if means—such as a conducting wire—are provided for current flow, then the ejected electron may contribute to an electric current that transmits the voltage along the path of the current flow.

In a Compton effect collision, the energy of the impacting photon is high enough that some energy is imparted to the electron—generally sufficient to effect a photoionization—but a new photon of lower energy then emerges to proceed towards further collisions. Of note—the ejection of an electron by the photoelectric effect is identified in a frame of reference in which the electron is initially bound in a solid so that it measurably moves into a different component of the solid—such as into the conduction band. However, the phenomenon also takes place upon impact with free electrons or with the electrons of non-crystalline atoms such as in a valence shell of a gas atom.

Compton effects occur in bound and free electrons because the fundamental process is not defined in the sense of displacement of the status of the electron. The electron is said to recoil—reflecting the fact that the photon has imparted energy to the electron. After the interaction, a photon then proceeds away having a lower frequency because energy was imparted. Fundamentally, the process of imparting additional energy to electrons from photons underlies the utility project of gaining an ability to extract usable energy from electrons. That additional energy has been delivered into the electron from an interaction with a photon and now becomes accessible for work use in a circuit or other system in which the added energy is subsequently retrieved from the electron.

The photovoltaic effect describes a special subset of the photoelectric phenomenon in which the material where the electron is ejected—usually a semiconductor—is structured so as to use a voltage to move the ejected electron into a circuit. In a semiconductor silicon solar cell this is accomplished with a thin n-type layer (excess electrons) applied to a p-type layer. Electrons cross from the n region to the p region (too few electrons) so that a depletion layer forms—but the n-region thus becomes positive and the depleted p-region becomes locally negative. When a photon crosses through the n-region to cause a photoelectric effect in the p-layer, the mobilized electron is affected the p-n junction field and moves into the n-region. The result is that the p-layer now has a new “hole” and the n-layer now has an excess electron. In the presence of a circuit, the effect of the extra electron spreads through the n-layer electron swarm at the speed of light and causes an electron at the far edge to be pushed into the wire of a circuit. In this fashion, a current begins to flow under a voltage potential supplemented by the ejection of the electron. The excess electron leaves the solar cell to do work in the circuit—providing the basis for work driven by electron flow.

Standard silicon photovoltaic cells can release one electron from one photon arriving from the sun typically with an energy of between 1 and 3 eV. On average a modern efficient solar cell can release one electron from about three photons—a 33% efficiency. The process involved results from the impact of the photon with a loosely held outer electron in a semiconductor. In this way, photons cause electricity to become available one electron at a time, as two or three photons strike the solar cell.

### 6. The Photoelectric Current and High Energy Photons

When a photon impacts into an atom, it can impart its energy to one of the electrons in an orbital shell of the atom. The various results of this impact are determined by the energy status of the arriving photon. In the case of low energy photons there may not be sufficient energy to displace the electron. The electron gains some energy based vibration but this energy dissipates. At a sufficient threshold energy, however, the electron gains enough energy to move from its valence shell into a higher orbital. This may mean a shift into the conductive band in a semi-conductor or into a freely flowing current band in metallic conductor. If the energy is great enough (higher frequency, not higher intensity of light), the electron may be ejected fully from the atom. These are the kinds of interactions that occur with photons of visible light with energies near a single electron volt.

High energy photons also produce a photoelectric effect but may also cause Compton scattering—which can eject an electron from its orbital. In either of these scenarios, the amount of energy is so much greater than the energy required to displace the electron, that a new photon will be emitted. The new photon will have a lower energy than the initial photon because some of the original energy was expended in energizing the first electron.

The secondary photon can then undergo further interactions, ejecting additional electrons until its energy is expended. The rate and distance over with these phenomena occur is dependent on a function of the density and Z-number of the medium through which the high energy photon is travelling. An annihilation photon at 511 keV (thousand electron volts) can travel nearly two centimeters through lead. Photons with energies above 1.022 MeV (million electron volts) can impact the atomic nucleus and induce pair production that yields a positron and an electron, but this phenomenon does not occur with photons arising by annihilation at rest energy because these photons have no more than half the required energy level.

Up to a certain point, increases in frequency of the arriving photon increase the kinetic energy of the displaced electron. At the surface of a metal target, this may result in an increase in effective voltage. In the classical experiment, a stopping voltage could be determined at which a voltage applied towards the metal's surface could stop the photoelectrons from being emitted into a vacuum. For a given frequency of incident photons (a given wavelength or color of visible light) the resulting voltage will not change no matter how intense the light, but more intense light will push out more electrons resulting in a greater electric current.

However, above a certain energy (frequency) level, one arriving photon will not be limited to producing one electron. Rather, there will be secondary and tertiary electrons and onward, each with various kinetic energies as the photon absorptions by Compton scattering leads to emission of new photons at progressively lower energy, each of which is capable of producing its own photoelectron.

When this process takes place in a conductor and if there is a voltage applied to the conductor the electrons ejected from their valence position will be able to participate in a current. In this setting, the current will increase both with the intensity of photon irradiation, and also with the energy, or frequency of the original impacting photon. This is counter to the classic experiments from the early 1900's because those did not deal with the secondary effects of high energy photons.

For a variety of reasons, although the physics is well understood, there has been little interest in or attention to this phenomenon of converting gamma radiation—in this case annihilation photons—into a means of producing a usable current.

High energy photons have been a concern for shielding from radiation from radioactive materials. Similarly passage of X-rays through tissues has been done for medical diagnosis, but not for purposes of generating electric currents. Gamma rays have been used to treat cancers by directing them into tissues to create damage by ionization and also injuries similar to thermal burns—but not to produce electric effects.

In astronomy or in medical imaging, the focus has been on detecting the arrival of high energy photon. The largest area of work in relation to annihilation photons relates to Positron Emission Tomography. Here, a sort half life positron emitter is incorporated into a molecule that will be introduced into a patient. When the nuclide disintegrates, an annihilation occurs and two 511 keV photons are emitted in exactly opposite directions passing out of the body with little or no restriction. The patient is placed in a detector ring of the PET scanner that identifies the photon arrival through a photo-electric effect in a material such as cadmium telluride. The system watches for “coincidence detection,” if two detections occur essentially simultaneously in two different detector elements, then a line drawn between these two detectors will pass through the site of the annihilation. As a number of annihilations occur, a series of different lines all passing through the source will identify that source location in the scanner. More recently, these systems are incorporated together with CT (computed axial tomography) or MRI (magnetic resonance imaging) scanners so that a structure generating emissions can be immediately correlated with an anatomical feature visualized by the CT or MRI scanner at the same time.

The biggest limitation to accuracy for the PET imaging component, however, is that after the nuclear disintegration, the positron travels for up to a centimeter before it loses enough energy to fuse with an available electron and undergo annihilation. These travels are in all different direction from the source. Filler in U.S. Pat. No. 5,948,384 disclosed that by having the disintegrations take place within a spinal ferrite nanoparticle, the distance of travel before annihilation could be reduced by more than six times because of the higher density of the ferrite relative to tissue water, thus dramatically increasing the spatial accuracy of PET scanning.

In astronomy, the detection of gamma rays plays a very significant role in understanding the structure of the universe. However, this type of detection is focused on being able to sense and measure the impacts.

Overall the logic has been that a large amount of electric energy is needed to produce X-rays so it would be irrational to use X-rays to generate electricity. Gamma rays in astronomy are in very tiny quantities. Nuclear fission and fusion produce a great deal of energy as heat, so there has been little interest in attempting to collect energy from the gamma radiation—rather there is just an interest in shielding and protecting humans from the effects of this ionizing radiation.

In basic physics, understanding the structure of light was among the original reasons for interest in the photoelectric effect. Einstein pointed out that the reason that increasing the intensity of light would produce increased current but not increased voltage is that light should be understood as existing in photons which are packets of energy at a certain frequency—wherein the strength of the energy is determined by frequency of the light. What we think of intensity with regard to a bright light is merely a matter of a larger number of photons, each with the same energy if they are from a standard source.

Compton scattering is classically considered as a critical experimental finding that proves the particle quality of photons. This is because it demonstrates that momentum is transferred from one photon to one electron and because it shows that a photon can result that has a different frequency than the frequency of the photon that first arrived. However, the use of Compton scattering as a means of ejecting electrons into the conduction band to produce a current has received far less attention.

From the point of view of the atomic shells, a high energy photon is likely to excite an electron from a deeper shell in the target atom (K or L shell). Therefore a much larger amount of energy can be absorbed in pushing that electron out of the atom than if the photon deposited its energy in the outer shell (M or N) electron.

These direct photoelectric effects dominate for gamma rays below 50 keV and are most important with high Z-number absorbing atoms such as lead (Z=82). However, in the energy range between 100 keV and 500 keV, the dominant effect is often Compton scattering. Here, an electron is ejected, but a new gamma photon at lower frequency is also ejected. For this effect the Z-number has less impact. Rather it is the number of electrons per gram—a parameter that is nonetheless affected by density and Z-number—that determines the distance of travel of incident gamma photons.

In lead, Compton scattering account for about 40% of the photon absorption at 100 keV and accounts for about 50% of the absorption at 511 keV. In aluminum (Z=13) Compton scattering accounts for about 80% of the absorptions at 511 keV. For elements with a Z-number around 30—the 50% point is as low as 50 keV.

In a Compton scatter event at 511 keV, as much as 95% of the energy is transferred to the electron, however, the remaining 25 keV in the resulting secondary photon will only transfer about a few percent of its energy to subsequent electrons. This phenomenon also contributes to the potential for a single incoming photon to eject multiple electrons.

The design of the current invention is intended to use a series of methods—including various electron emitting processes in absorbing materials and also optimally designed mirrored chambers that are effective for mirroring higher energy photons, to reflect secondary lower energy electrons—to use each high energy photon to force multiple electrons to join a circuit and contribute to voltage potential. At the maximum efficiency, each of the two 511 keV photons from an electron/positron annihilation can generate about 500,000 electrons. Thus the overall potential efficiency is 1 million electrons produced per annihilation event where it takes about 3 solar photons to produce one electron in a high efficiency solar cell (effectively “⅓ of an electron” per photon). The overall efficiency difference, therefore, is potentially as great as 3 million to one for this process of electron capture from high energy photons. Devices provided in this patent to accomplish this step are part of the invention but are used in cooperation with other components to reach much higher efficiency.

Where compact storage of a photon source for photovoltaic conversion is required, it is readily apparent that positron based electron release systems can provide very compact and efficient fuel 1 millicurie of ⁵²Mn can produce 37 million positrons per second so maximum conversion will result in 37×10¹² electrons per second (6 microAmps).

### 7. Generating Positrons

Positrons are anti-matter electrons and one common way they are formed in our matter universe is when certain unstable isotopes of certain elements undergo nuclear transmutation. This occurs generally in nuclides of elements that contain a relatively high number of protons relative to the number of neutrons.

For instance, manganese is element number 25 because it has 25 protons. The usual atomic weight of manganese is 54 because it has 29 neutrons along with its 25 protons (25p,29n). However, using as a target some ⁵⁰Vanadium (stable common isotope is 23 protons and 27 neutrons along with a small amount of some naturally occurring long half life isotopes) and a high energy bombardment (at 14 MeV in a cyclotron) with ³He ions (a nucleus with two protons and one neutron) being hurled at the target, will result in ⁵²Mn production. This process actually results in several different nuclides. These include ⁵¹Mn (25p, 26n), ⁵²Mn(25p,27n), and also ⁵¹Cr(24p,27n), ⁴⁸V(23p,25n) and ⁴⁹V(23p,26n). The ⁵¹Mn decays very rapidly and chemical separations are used to isolate the manganese from the chromium and vanadium. The result is some relatively pure ⁵²Mn(25p,27n) which has a high ratio of protons to neutrons compared to the stable isotope ⁵⁴Mn(25p,29n).

This type of proton rich nuclide has a propensity to undergo transmutation by the change of one of its protons into a neutron. This change is accomplished by the emission of a positron and an electron neutrino. When this happens to an atom of ⁵²Mn(25p,27n) it is transmuted to an atom of ⁵²Cr(24p,28n) which is a stable isotope.

Summaries of various nuclei that emit positrons as well as the periodic table are readily available in print and electronic form and are well known to those skilled in the art. A substantially complete list of common positron emitting nuclides is included in a copy of the “Table of Isotopes” page 11-2 to 11-174 from the CRC Handbook of Chemistry and Physics, 95th edition (2014-2015), W. M. Hayes, editor in chief, CRC Press, Taylor & Francis Group, New York, which is attached to related filing application Ser. No. 62/034,713 as Exhibit 1 to that provisional application and is effectively incorporated herein, into the four corners of this application file, by this reference.

In detail, the protons and neutrons of the atomic nucleus are composed of fundamental particles—in particular the fermions up quark (charge +⅔) and down quark (charge −⅓). A proton has two up quarks and one down quark resulting in a charge of +1. Neutrons have one up quark and two down quarks resulting in a net charge of 0. The weak interaction can permit a quark to change flavor from down to up resulting in an electron emission, or from up to down resulting in a positron emission along with emission of an electron neutrino. During positron emission, the nucleus keeps the same atomic mass, but because a proton changes to a neutron, the atomic number drops by one (e.g. changing ₁₂Mg²³ into ₁₁Na²³+e⁺+νₑ).

### 8. Beta Emitters

As an additional component, certain beta emitting nuclides are also useful. These include ⁶⁰Cobalt (T_{1/2}=5.2 years), ⁵⁹Iron (T_{1/2}=44.5 days); ⁴⁷Scandium 3.3 days; 90 Yttrium (T_{1/2}=2.7 days), ⁹¹Yttrium (T_{1/2}=53.5 days), ⁹⁵Niobium (T_{1/2}=35 days; ⁹⁹Molybdenum (T_{1/2}=2.7 days); ¹⁰³Ruthenium (T_{1/2}=39.3 days); ¹¹¹Silver (T_{1/2}=7.4 days); ¹⁸⁵Tungsten (T_{1/2}=75 days); ⁸⁵Krypton (T_{1/2}=10.7 years); and ¹³³Xenon (T_{1/2}=5.2 days).

Overall, the full array of the elements of the periodic table, including all of thousands of nuclides, their disintegration emission profiles, types of emissions, half lives and energies are well know to those skilled in the art and are detailed in sources such as the Table of Isotopes in CRC Handbook of Chemistry and Physics, 95th edition (2014-2015), W. M. Hayes, editor in chief, CRC Press, Taylor & Francis Group, New York. In that reference, at pages 11-1 to 11-174, attached hereto (Exh. 1). This Table of Isotopes lists most known isotopes of every element as well as providing the decay mode and decay energy for most. This information is also readily available in elaborate dynamic online resources such as at www.ptable.com. A periodic chart with numerous relevant nuclides—noting a number of important beta emitters and gamma emitters is also included in U.S. Pat. No. 5,948,384 although challenges in printing faced by the United States PTO demonstrably limit the effectiveness of trying to usefully incorporate a periodic chart in a patent filing. Thus, the decay type and decay energy for all of the elements revealing the types of gamma and beta emissions is readily available and can be reasonably viewed as a standard universally present and universally understood set of working tools for anyone skilled in arts relating to the gamma and beta emissions of the elements.

### D. SUMMARY OF THE INVENTION

This disclosure reveals several related methods and devices to use positron electron annihilation reactions for energy storage and electrical work. In the first aspect, the disclosure provide for methods of producing and deploying positron emitters that provide for a fluid based positron source. The chemical and material aspects of the disclosure are the unifying theme because they make a wide variety of commercially useful new applications of positron systems feasible.

In a first aspect, when a solar array is used to collect energy to cause a cyclotron to produce positron emitting nuclides, a battery effect is provided. The availability of sunlight varies with time and location, but when a long half life positron emitter is produced, that energy becomes available in a concentrated portable form that will be emitted on a steady basis—over hours, over days, over weeks or over many years depending on the half-life of the emitter chosen to be produced.

In a second aspect, this disclosure relies on metal positron emitters such as manganese-52 wherein they can be dissolved and then incorporated into coated nanoparticles susceptible to being solvated so that a readily storable liquid energy source is created that provides positron emission.

Having provided for conveniently available positrons, the disclosure reveals convenient usable systems for exploitation of the annihilation reaction in three related aspects. Firstly, positrons are emitted to use their high kinetic energy of nuclear disintegration to pass through low density insulator capsules to produce electron depletion in a target. As positrons enter and annihilate electrons in the target, the target becomes positively charged and can provide a static electric field source. Various uses of these static positive electric field sources are disclosed including water desalination by deionization, ionization chambers for fluorescent light, and ion drive plasma rocket engines.

The annihilation photon produced by the electron-positron reactions have a high energy—a million times the electron voltage of sunlight—and so pass through existing solar cells and mirrors without depositing any energy. However, novel materials and structures based on high Z-number components and novel conductors can be deployed to cause the annihilation photons to produce electricity in analogy to sunlight in a solar cell. The high energy of these photons means that very large numbers of electrons can be driven into electric currents for each annihilation event.

Since the photons come from a liquid rather than from the sun, the devices that accomplish this look very different from a solar array. This provides the opportunity for very small devices to extract electricity from the positron fluid driven annihilations. This provides the basis for very novel devices such as an internal annihilation engine that can use this fuel source to drive pistons or increase the efficiency of a jet or rocket engine.

Finally, the use of dense concentrated liquid carriers of positron emitters and the deployment of these sources in complex systems for photon capture also opens the opportunity for sustained use of pair production chain reactions for ongoing production of positrons. This is accomplished using the high voltage electric fields—from materials with electrons depleted by positrons—to drive electrons and positrons through magnetic focusing grids to achieve kinetic collisions required to support pair production.

### E. BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 is a diagram of one of one of the devices used to convert the unique new types of energy into mechanical work. The two linked structures each depict a small independent piston system wherein energy is captured from high energy photons to produce electricity. The electricity creates a current in a solenoid that magnetizes a chamber containing superparamagnetic material. Magnetization increases the apparent effective density of the fluid and forces the piston out of the chamber, thereby moving the unit along a connecting fiber.

FIG. 2 depicts one of the types of internal annihilation engines disclosed. It contains larger versions of the solenoid and piston system driven by locally generated electricity, in this case with the pistons attached to a cam shaft.

FIG. 3 is a diagram of a process whereby an antimatter positron is emitted from a carrying solution in one component and then travel with the high nuclear disintegration energy to penetrate low density insulation of a second component and then enter a conducting substance therein where it undergoes matter-antimatter annihilation. The process gradually depletes the second substance of electrons turning it into a positively charged electric field source.

FIG. 4 is a diagram of the process shown in FIG. 3 but where the source of positrons is in a cylinder inside a surrounding ring of target material to be depleted of electrons. The cylinder carries a liquid solution carrying the positron emitters but the fluid also carries particles depleted of electrons by previous activity of β⁻ emitters ejecting electrons. Thereby the solution gradually becomes electrically neutral so it may be removed from the interior once charging of the surrounding ring is completed.

FIG. 5 is a diagram of gas ionization chamber in which a disk of material that has been partially but significantly depleted of electrons provides a positively charged electric field. That field requires no ongoing electric input, but is able to operate a fluorescent light system by means of the ionization system

FIGS. 6A and 6B respectively provide side and top views of a levitation and drive system used to support a train car on rail wherein insulation coated conductor disks previously made into carriers of a positive electric field by positron mediated electron depletion are used to provide a frictionless support and electric field moderated drive system.

FIG. 7 is a cross sectional diagram of concentric rings of a rope-like structure with layers of different types of materials and carriers that are used to carry out matter-antimatter annihilation in a structured system. The structure is capable of using photoelectric and photovoltaic events to capture electricity generated by the impact of high energy annihilation photons analogous to the use of sunlight to generate electricity in a solar cell. This structure additionally uses high electric field voltages to accelerate positrons and electrons into kinetically energetic collisions to promote pair production to support a matter-antimatter chain reaction for positron production.

FIG. 8A demonstrates a disposition of four magnets to cause a funnel effect capable of concentrating electrons and positrons as they move toward each other to undergo collision and annihilation. FIG. 8B demonstrates a quadrupole arrangement of this type where in electromagnets are use, but FIG. 8C depicts an array of magnets cast in a sheet with gel and superparamagnetic carriers for in situ magnetization. The sheet concentrates electrons and positrons but can be rolled into a component layer of the type of structure depicted in FIG. 7.

### F. DETAILED DESCRIPTION OF PREFERRED EMBODIMENTS

The structures relied on for the positron system include the following component aspects.

### 1. Detailed Description of Production of ⁵²Mn from Vanadium

The isotopes that emit positrons have various half-lives which are well understood by those skilled in the art of nuclear physics. The half life refers to the time it takes for 50% of the atoms of the isotope to disintegrate. The half-life is important to the design of various positron systems because the requirements will vary depending on the design. In some cases, such as an interplanetary spacecraft, it may not be feasible to produce positron emitting isotopes or nuclides from incoming sunlight. Instead, it may be preferable to produce a mass of positron emitting nuclides that will gradually decay over several decades.

In other situations, it may be convenient to produce and replace nuclides on a daily basis. In this situation there is an attraction for shorter half lives if the materials are used where they might become subject to accidental release into a populated environment causing a risk of harmful human exposure. In those situations a nuclide with a half life of a few hours or a few days would have the advantage of being substantially self-eliminated within a reasonable period of time.

For a variety of energy storage and use situations, a useful choice would be the ⁵²Manganese isotope which has a half-life of 5.591 days. This isotope can be produced by a variety of methods in which, for example, a metal foil is bombarded with nucleons. This results in the addition of some of the nucleons to the atomic nucleus of the target. In one such manifestation, a foil of vanadium metal that is 0.25 mm thick and 20×30 mm in size is irradiated by ³He ions that are accelerated to the 10 to 25 MeV range but preferably around 14 MeV in the internal beam of an isosynchronous cyclotron. An effective current of 100 to 500 nanoAmps is used to irradiate the target for between 10 and 30 minutes.

The result of irradiating vanadium with a natural mix of its own isotopes in this fashion is to produce isotopes of vanadium, chromium, and manganese. The manganese isotopes include ⁵¹Mn which has a half life of 46 minutes and ^{52m}Mn which has a half life of 21 minutes. With the elapse of eight hours after irradiation, these have undergone the passage of numerous half lives and are reduced to negligible amounts.

The vanadium, chromium, and manganese are separated chemically by dissolving the foil in five milliliters of 40% nitric acid. In one method, this solution is then treated with twenty milliliters of a saturated solution of potassium iodate and the solution then boiled until the color changes from green to yellow. It is then cooled, adjusted with sodium hydroxide to reach a pH of 10 and then extracted with 40 ml of a 0.1 Molar solution of 8-hydroxyquinoline in chloroform. The organic phase is then washed with 20 ml of an aqueous phase and adjusted again with sodium hydroxide to pH of 10. All of the manganese will now be in the organic phase, while all of the vanadium and chromium will be in the aqueous phase. The manganese is then extracted, and treated to extract the metal chloride. This paragraph is but one of thousands of methods well known to those skilled in the art of metals chemistry which is capable of separating various elements from each other. There are additionally a wide variety of methods well known to those skilled in the art of physics and chemistry which involve heating to separate liquid metals based on melting temperature, centrifuge methods, ionic separation chromatography methods, and chelation methods which can purify and separate various elements. Further details of this method are included in the attached publication “Production of Manganese-52 of High Isotopic Purity by 3He-Activation of Vanadium” by Sastri, C S, Petri, H, Kueppers G., and Erdtmann G., International Journal of Applied Radiation Isotopes 32:246-247 (1981).

### 2. Cyclotrons and the Process for Obtaining Positron Emitting Nuclides

The exposure of a metal foil to a beam of nucleons can be accomplished using a linear accelerator or a cyclotron or various other particle accelerators. In the preferred embodiment, a cyclotron is used because these can be small compact units two or three feet in diameter or smaller that can be operated by a 2 kilowatt power input. This amount of electrical power is readily generated by an array of solar panels used on a typical home—such as 20 square feet of solar panels.

The electrical power is mostly needed for two tasks. The first task is to maintain a strong magnetic field in a pair of magnet disks placed in such a way that there is a gap between the two disks. The magnetic field is established to run from the surface of one disk up into the surface of the other disk. This strong magnetic field can be maintained with strong electric currents disposed around a ferromagnetic core. Alternately, when superconducting magnets are used, the unit requires a liquid nitrogen outer shell and a liquid helium inner shell in a thermos.

The electricity that generates the magnetic field is introduced into a continuous circular path and then continues to circulate when the wire is made superconducting by the low temperature provided by the liquid helium. The advantage of the superconducting system is that it can help provide a very powerful beam of nucleons with very little electrical power input.

The purpose of the resulting magnetic field is to bend the course of the injected ions. The key to a cyclotron type device is a pair of D shaped electrodes called Dee's. One Dee is held at a positive voltage and one held at a negative voltage. The two are each switched from positive to negative at regular intervals controlled by a square wave amplifier operating to switch them each from positive to negative at radiofrequency rates. Each Dee fits between the top and bottom half of the magnet, facing each other. They are hollow and are open at the side facing the operating diameter line of the cyclotron. When the positive ³He ions are first injected into a vacuum maintained throughout the inner space of the Dees, they are drawn toward the curve of the Dee that is negative. However, the beam can't travel in a straight line because of the magnetic field which causes the beam to curve through a 180 degree arc and just as it starts to rush out of the negative Dee, the field is reversed and the Dee on the other side become negative while the Dee they are leaving becomes positive. This accelerates the beam into the other Dee where the magnet curves the beam back to the gap again. With each pass, the beam moves faster and goes through a wider arc because of its momentum, gradually spiraling outward with each pass until it is sent out of the cyclotron to strike the target.

Because the Dees are hollow electrodes, they demonstrate a Faraday Cage Effect whereby, despite the high voltage, there is no electric field present in the hollow space. The field only exists in the diameter line space between the two Dees.

The second use of the electric power is to operate the amplifiers driving the square wave radiofrequency component that causes a field disposed along a line that is a diameter line across the center of the magnet to alternately attract and repel the charged nucleons after they are injected near the center of the magnet. The beam follows a spiral course, making a full half circuit in the same amount of time even as the beam travels into outer arms of the spiral. The design of cyclotrons—and of optimized versions such as a synchrocyclotron or isochronous cyclotron that, for instance, correct for relativistic effects as the beam reaches very high speed—is well known to those skilled in the art of nuclear physics.

Where ions such as ³He are used, the ³He can first be purified by various methods including gas diffusion through ultrathin polymer membranes. The gas is then allowed to leak into the vacuum accelerator chamber in proximity to a heated electrode that emits electrons and ionizes the gas. As the atoms ionize, they become subject to the electric field of the cyclotron DEEs. Alternately, the ions are generated in a magnetic containment chamber where the gas is bombarded with electrons and the resulting ions then drawn into an injection port by an induced electrical field.

The targets may include a metal foil including iron or other metals that can undergo transformation to desirable positron emitters of appropriate half life. Alternately a thin film of flowing suspended nanoparticles can be passed through the beam target chamber so that they can be used in one of the methods or structures of this invention as soon as the positron emitting components are formed.

Overall, with a superconducting system, very little electric power is required to maintain the magnet field and most of the power is for the amplifiers that alternately charge the two DEEs to drive the beam that generates the positrons. A typical output is 6.5 μCuries/μAmp h⁻¹ Because of this, and because each Helium ion that converts an atom of vanadium into ⁵²Mn can ultimately yield up to one million electrons, the process of storing electrical input in the form of positron emitters can result in an overall very large amplification of the electrical energy input. The amplification occurs because anti-matter will be formed when the nucleus transmutes by positron emission. The positron will interact with an electron and will be converted from matter into energy in a matter-antimatter annihilation with two photons carrying the 1.022 million electron volts of energy to be exploited.

A typical medical cyclotron can produce 37 Gigabecquerel=1 Curie of a positron emitting nuclide such as ⁸⁹Zr per day. One Curie represents 3.7×10¹³ decays per second. This will readily equal 2×10¹⁸ positrons per day output in a pure volume of ⁸⁹Zr, representing about 10 μmoles. This can be accomplished with a 12.5 MeV beam that produces about 40 MBq/μAh resulting in 7 GBq in 5 hours using a beam energy of 30 μAmps. Of note, however, this number of positrons, when viewed in electrical terms, will deplete a metallic solid composed purely of the ⁸⁹Zr of about 0.3 coulombs in a volume of a few milligrams and thus can create a voltage of very high magnitude—as detailed below.

The relevant parameters in cyclotron design and cost are the MeV of the acceleration required and the beam current in microAmps. The necessary MeV is determined by the desired nuclide production reaction. For several of the positron emitters that are useful for this invention, the MeV is relatively low—in the range of 10 to 30 MeV. The range of MeV available in commercially available cyclotrons has been reviewed recently by Papash, A. I. and Alenitskii, Yu. G. “Commercial cyclotrons. Part I: Commercial cyclotrons in the energy range 10-30 MeV for Isotope Production” Physics of Particles and Nuclei, 39:597-631 (2008). An MeV of over 500 could be required for accelerating large particles such as uranium ions, but most of the positron preparations methods require acceleration of smaller lighter particles such as protons (hydrogen nuclei) or helium nuclei. There are various machines available for biomedical use with a beam intensity of 20 or 30 microAmps which have been installed in many medical imaging facilities, but newer commercial cyclotrons are capable of over 1 milliamp beam current. A cyclotron with a beam energy of 20 MeV and a beam intensity of 130 milliamps could produce 1.2 TeraBq of ⁸⁹Zr per day, representing about 0.5 milliMoles—about 40 milligrams.

Very small cyclotrons for small batch work can work usefully with nanoAmps beam currents but increasing the beam current increases the rate of production of nuclides. Efficiency and simplicity of cyclotron design can be improved when a machine is designed for producing a particular selected nuclide as opposed to variable designs capable of a wide variety of energies and beam ion sources. It would be likely that specially simplified and optimized cyclotrons would be used for positron production for the energy storing and generating systems disclosed in this patent application. Target design, for instance is much simpler than for gas or liquid targets. A metal foil target of optimal design can be treated and shifted into different positions in the beam, then removed for processing on a continuous basis—essentially scrolling into the beam and then out after irradiation for processing.

### 3. Purification of Potassium-40

It is important to also consider potassium-40 a very long half life nuclide (1.248×10⁹ years) that occurs naturally at a rate of 120 parts per million of potassium atoms on earth (natural abundance of 0.0117%). It decays with a β⁻ process to become calcium-40 (89.28%), and also manifests an electron capture decay (10.72%) to argon-40. The remaining 0.001% of the time it decays to become argon-40 by emitting a positron. Although potassium-40 ranks third after ²³²Th and ²³⁸U in terms of contribution to the earth's natural radiogenic heat, there is currently little industrial purification of ⁴⁹K. This can be accomplished by the usual isotope separation methods well known to those skilled in the are such as by centrifugation to take advantage of the slightly different weight, by diffusion, or by laser absorption methods. Most potassium-40 separation is carried out by the electromagnetic method that is similar to mass spectroscopy. A form of potassium is heated to yield ions—optimally this is potassium-iodide heated to 250 degrees centigrade. A voltage is applied to create a beam and this beam is directed past electromagnets. The electromagnets bend the beam, but achieve different bending angles for different masses. In this fashion, a potassium-40 beam fraction can be sprayed onto a collector and harvested (see for instance Love, L. O. & Bell W. A. “The Electromagnetic Concentration of Potassium-40,” USAEC Technical Information Service Y-623, (1950).

Once such a purification is accomplished to increase the concentration of 40K by a thousand fold so that it composes 10% of the potassium sample. There is no means to separate these nuclei as to the type of beta decay that will occur (β⁻, EC, or β⁺). Therefore, a strategy of using a moderator to decrease the energy and then using an electric field to sort by charge as to β⁻ or β⁺ emission would allow production/collection of naturally occurring positrons. Despite the low yield and the energy expense for production, this type of positron source can be used for initiation of a positron chain reaction production system as described below.

### 4. Matter-Antimatter Annihilations in Optimal Materials

The purified ⁵²Mn, one of the preferred embodiments, is chemically extracted and dried as the ⁵²MnCl₂. The ⁵²MnCl₂ is incorporated into nanoparticles according to the method provide by Filler in U.S. Pat. Nos. 6,562,318, 5,948,384 and 6,919,067. In these methods, the ⁵²MnCl₂ along with FeCl₂ and FeCl₃ dissolved in hydrochloric acid are then introduce into a bath of a hydrophilic polymer such as a high concentration dextran solution. Then at 60° C. while being stirred, a solution of ammonium chloride is dripped into the mixture. This causes formation of superparamagnetic nanoparticles of mixed ferrite spinel crystals that are doped with the ⁵²Mn, coated with the dextran so that they are fully solvated and remain in solution, and are capable of control and direction by the use of magnetic fields.

The initial precipitate is then subject to a chelation bath to accomplish separation of manganese and iron hydroxides to produce an hydroxide free solution. This separates particles of identical size and similar chemical composition so that only stable, insoluble ceramic spinel remains, according to the method of Filler in U.S. Pat. No. 6,919,067—see also U.S. Pat. No. 5,614,652. It should be understood by those skilled in the art of nanoparticle and microparticle fabrication that there exists a wide array of equivalent methods for producing particles or for encapsulating in various polymers and coatings including dextran, carbon, acrylamide, chitosan and a wide variety of other coatings, organic and inorganic, well known to those skilled in the art. Similarly, the metal salts can be incorporated into micelles or even distributed as metal that is metallurgically incorporated into a positron emitting alloy, where the resulting alloy is left as a metal, shaped into various forms, ground into fine particles, and the particles then suspended in oils or polymers or other vehicles. The particular advantage of the preferred embodiment is that like gasoline, it can be pumped into chambers and flowed, stowed, divided and carried in an infinity of ways and introduced into fine chambers or pistons or passed in thin flows over various surfaces. Because of the ceramic qualities of the hydroxide free ferrite preparation, the preferred embodiment is non-reactive, non-corrosive, easy to collect and clean if spilled, and is well solvated, resisting extraction from solution even when centrifuged at high speed. It additionally has all the favorable properties of a superparamagnetic ferrofluid. The materials and methods for production—iron, chloride, hydrochloric acid, ammonium and dextran are all very inexpensive. Additionally in case of a spill, the vehicle—water—evaporates and dextran can be digested by bacteria—removing the solubility—or cleansed by dextrase enzymes, or burned off.

From this perspective, dextran coated ferrites have the unique value of being biodegradable. They can require not only radiation, but inclusion of bacterial retardants—such as iodine or antibiotic agents—in the suspension fluid in order to prevent unwanted deterioration. However, the benefits of biodegradability in case of any fuel spill are a significant beneficial consideration.

Additionally, the nanoparticles solution can be mixed with various gelation materials such as polyacrylamide monomers or various other monomers. Alternate preparation with other coatings allow for dissolving in various other monomers capable of conversion to gels or solids with the application of various catalysts or secondary components.

### 5. Spinel Moderated Positron Emission and Chelate Fluids

Another special advantage of disposing the ⁵²Mn within spinel or other metallic crystals is that although the fluid behaves like water, the nuclide is actually incorporated into a material that has about 6 times the density of water. The distance of travel of a positron after a nuclear disintegration and before it undergoes annihilation, is determined by the density of the medium through which it travels—see Filler U.S. Pat. No. 5,614,652, and U.S. Pat. No. 5,948,384. The effect, therefore, is to concentrate the annihilations so that they take place about ten times closer to the disintegration than they would if the ⁵²Mn was dissolved in water. This effect will bring the annihilation about a centimeter or two closer to the emitter. This greatly increases the intensity of the overall stream of emission of the resulting annihilation photons as well as the energy density and helps improve control over exactly where the photons will be emitted.

The concept of energy density is important in usable fuels. In a positron emitting fluid with the emitting ions solvated in water the material would require up to six times the volume of such “positron fuel” to deliver the same amount of positron energy source required when the spinel moderated—or similar—crystal carriers are used. The carriers have significantly higher density than water and result in a reduction of the distance of travel of a positron between the point of emission and the point of annihilation. This effect becomes most important when it is necessary to provide a high density or concentration of emission in a small space—a requirement, for instance, in the motor system described below.

Alternately, for systems such as the positively charged field sources described below, the maximum distance of travel after annihilation may be preferred. In this situation, the metal cation can be captured by chelation molecules such as EDTA (ethylene diamine tetraacetatic acid), DTPA (diethylene triamine pentaacetic acid), or NTA (nitrilo triaacetic acid) after, e.g. ⁵²MnCl₂ is dissolved in aqueous solution. The chelation molecule provides a means to help avoid chemical reactions that can occur with the unchelated dissolved metal cation. An amount of the chelation molecule that is greater than the stoichiometric amount of the target metal ion is used. The transition from manganese to chromium brings about a moderate increase in solubility, but both cations are within the chelation range of these chelators.

Another consideration with chelators is that they make it possible to provide well solvated fluid with, e.g. metals that have very low solubility as simple ions. This is thoroughly demonstrated in the palladium solvation methods disclosed by Filler & Lever in U.S. Pat. No. 6,919,067 and also see palladium particle methods in Filler & Lever U.S. Pat. No. 5,614,652.

### 6. Materials for Matter-Antimatter Annihilations for Producing Electricity

Another advantage of the solvated spinal positron emitters is that the liquid can either be mixed with other spinel, garnet or alternate inert solvated nanoparticles or can be flowed into tubing or sheets closely approximated to other tubing and sheets containing the other nanoparticles.

This second set of nanoparticles is provided for the purpose of providing a wide array of high Z (high atomic number) nuclei with a wide array of bandgap properties capable of receiving energy from photons and emitting lower energy photons or emitting electrons.

Traditional photovoltaic cells used for solar energy capture can only capture energy from visible light photons that have energies in the range of 1 electron volt. If a photon with lower energy enters the atomic orbital, then the energy may be absorbed by an orbiting electron with some change of orbit but no useful photovoltaic or photoelectric effect. If a photon with a moderate excess of energy—e.g. 1.3 electron volts is delivered, then the one electron volt that matches the bandgap will be absorbed usefully, but the additional energy will not be productively used.

The problem of obtaining a photoelectric or photovoltaic effect from gamma rays or X-rays has long remained unsolved. A slight increase of range can be accomplished with quantum dots placed over the surface of the photovoltaic cell so that a decrease of energy will result and more of the high energy photons will be able to interact usefully with the solar cell atoms.

However, for a high energy photon with 500,000 times the energy of a visible light photon, it has been appreciated that the entire apparatus will be effectively transparent to the photon—it will pass through without absorption as if nothing was there. This occurs whether the surface of the cell is a silver coated glass mirror or even a lead foil sheet. This problem has been advanced widely as a reason why there is no useful way to get a photovoltaic effect from a gamma ray.

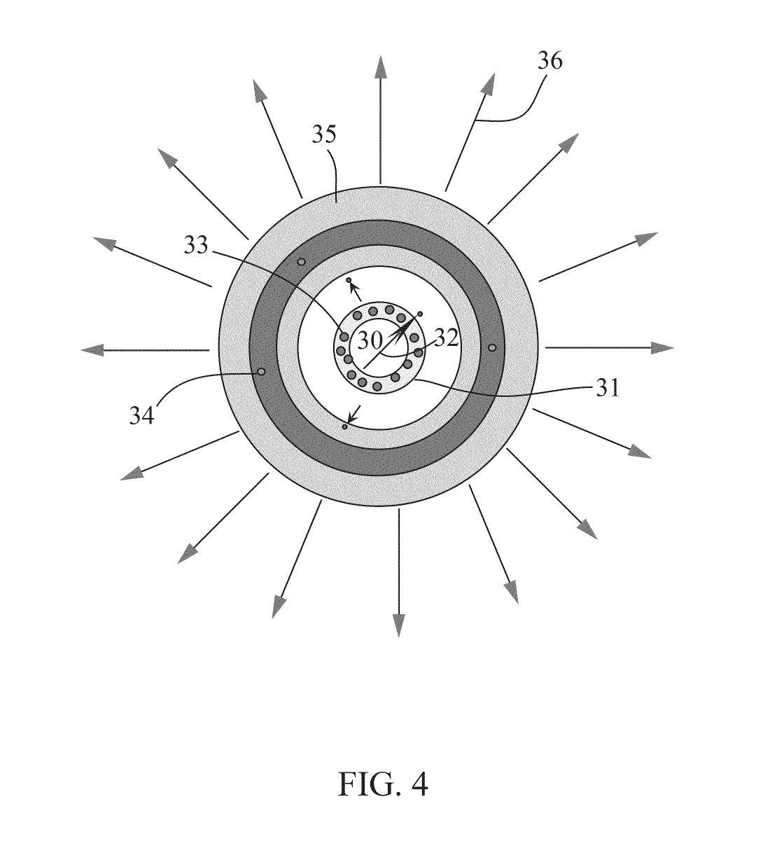

Nonetheless, as shown by Filler in U.S. Pat. No. 5,948,384 (FIGS. 4a and 4b), when dense nanoparticles are immobilized in a gel, and high energy X-rays are passed through, the zone of the particles does cause absorption. In that experiment, Filler prepared a cast polyacrylamide gel in a glass beaker wherein several test tubes had been placed when the gel was polymerized. The tubes were removed after polymerization leaving behind a series of wells. Into each well, Filler poured a different polyacrylamide mixture containing one of various elements such as iodine (Z=53), iron (Z=26), magnesium (Z=12), and Terbium (Z=65). This array was then subjected to CT (computed tomography) scanning in order to pass high energy photons (X-rays) through the medium and to measure the Hounsfield Units of the various materials—which is a measure of absorption of the photons. The high Z-number terbium garnet nanoparticles at a concentration of 30 mg/ml resulted in near complete absorption of the X-rays while a 10 mg/ml mixture of the terbium garnet nanoparticles was comparable to the low absorption of the 30 mg/ml spinel ferrite nanoparticles (low Z).

This experiment demonstrated that by forming well solvated high Z-number nanoparticles it would be possible to have good control of absorption of high energy photons. Additionally, however, the absorption will be accompanied by photo electric effects and photovoltaic effects.

In order to capture the emitted electrons it is simply required that the fluid medium in which the various particles are solvated should be an electrolyte solution capable of conducting electricity. Various ions dissolved in the aqueous solution can yield a conductive fluid, including potassium iodide, lithium nitrate, and a wide variety of other electrolytes well know to those skilled in the art of the chemistry of electrolyte solutions. Generally, the ions will be selected to have little or no corrosive effects on the nanoparticles.

Optimally, these high Z-number photon moderators can be in conductive rather than non-conductive particles or can be chelated as individual atoms in chelators such as EDTA, DTPA, NTA or others. Examples of conductive crystals include materials such as substituted LLZO (Li₇La₂Zr₂O₇) using lithium as the conducting ion and substituting Ta for Zr to improve stability of the crystal and minimize reaction with the lithium—an example being Li₇₋ₓLa₃Zr₂₋ₓTaₓO₁₂ (x=0.25)—see Yang et al, Densification and lithium ion conductivity of garnet-type Li₇₋ₓLa₃Zr₂₋ₓxTaₓO₁₂ (x=0.25) solid electrolytes Chin. Phys. B 22 (7) 078201:1-5 (2013).

Natural garnet has a crystal structure of Ca₃Al₂(Si0₄)₃ or 3CaO.Al₂O₃.3Si0₂. An analogous structure is achieved with the composition Ln₃Fe₅O₁₂, wherein Ln is a lanthanide element (see Filler U.S. Pat. No. 6,562,318) or Narayanan et al. “Enhancing Li Ion Conductivity of Garnet-Type Li₅La₃Nb₂O₁₂ by Y- and Li-codoping: Synthesis, Structure, Chemical Stability and Transport Properties”. J. Phys Chem 116:20154-20162 (2012). Similarly various spinel crystals—including the superparamagnetic positron emitting nanoparticulates described above—can be made conductive by doping with gallium—see Shi, Y, et al “Self-Doping and Electrical Conductivity in Spinal Oxides: Experimental Validation of Doping Rules” Chemistry of Materials 26:1867-1873 (2014) and Honma, et al “Spinel-type crystals based on LiFeSiO4 with high electrical conductivity for lithium ion battery formed by melt-quenching method” J Chem Soc Japan 120:93-97 (2012).

### 7. Typical Methods for Nanoparticle Preparation

The following methods are intended to show working examples and variation methods and are in no way intended to be exclusive of other methods, known to those skilled in the art, capable or producing useful particles. These are laboratory scale methods as described but are capable of scale up to industrial scale according to approaches well know to those skilled in the are of scale up of chemical synthesis methods.

### A. Aqueous Precipitation Method

i) Preparation of Reaction Solution

Use double distilled water (not de-ionized) to make up the reaction mixture. The following steps are conducted. A water bath is set up at 60° C. Add 3.0 ml of 33% NH₃ to 9 ml of hot ddH₂O (to make up a greater than 7.5% NH₄OH solution) and leave standing in a capped universal tube in the water bath to bring the solution to 60° C.

ii) Initial Metal Salt Solution in Hydrophilic Polymer

Dissolve 2.5 gm Dextran (e.g. MW 10,000) in 4.0 ml of ddH₂O to make a fully saturated or supersaturated solution. This process requires a series of steps with gentle shaking or tumbling over about 30 minutes. An ultrasonic sonicator may be used to clear bubbles. No undissolved material should remain based on at least visual inspection. The resulting volume of the fully mixed solution should be about 5.5 ml.

The chloride salts of the of 2+ and 3+ oxidation state metals, eg. FeCl₂, FeCl₃, MtCl₂, MtCl₃ where Mt is a positron emitter or other useful metal nuclide, dissolved in the saturated or supersaturated solution of 1,500 to 10,000 MW dextran, preferably 10,000 MW in a ratio near Mt(II)1.0:Fe(III) 2.0 at a concentration of 0.2 to 1.0 molar, and at a temperature of 0°-60° C., depending upon the final particle size distribution desired but preferably at 50° C. and where Mt is the divalent cation of a transition metal or of a mix of transition metals.

To make the ferrite dextran solution, add 450 mg of the FeCl₃.6H₂0 (MW 270.3) to the dextran solution. Sonicate briefly after adding the FeCl₃. Any trivalent lanthanide chloride may be substituted at high ratio for 10 to 50% of the FeCl₃. When this is done, the subsequent post-reaction incubation is extended to two hours. Trivalent cations (such as Sc(III)) may be used in low ratios if they are stoichiometrically balanced with monovalent metal salts, preferably LiCl.

Next add 200 mg FeCl₂.4H₂0 (MW198.8) to the dextran-FeCl₃ solution. The dextran solution should be heated only briefly to avoid recrystallization or sludging. The FeCl₂ must be fully dissolved.

For some metals, such as PdCl₂, it will be necessary to dissolve the metal by allowing 87.5 mg of the PdCl₂ to sit in 0.5 ml of 5N HCl acid to dissolve overnight. The fully dissolved PdCl₂ solution can then be added to the Dextran-FeCl₃ solution. In all cases stoichiometrically correct amounts should be calculated and used.

iii) Precipitation Step

The ferrites are precipitated by addition of the of 5 to 10%, preferably 7.5% aqueous solution of NH₃ at 60° C. in a fume hood. Upon addition this will reach a pH of 9 to 12 and preferably pH 11 (about 15 ml added to 7.5 ml of dextran/metal salt solution). The addition is done in a slow steady stream from a pipette so that the volume of the ammonia solution is streamed into the dextran saturated metal solution in a series of 1 ml aliquots, each delivered over about 20 to 30 seconds. There should be continuous swirling of the metal solution—but a magnetic mixing bar generally should not be used. All 12 ml of the ammonia solution will be required for the 5.5 ml of metal chloride—dextran solution.

The black solution that is the product should be left to stand in the 60° C. water bath for 15 minutes for Fe/Fe particles, but this incubation should be extended up to two hours to accommodate slower crystallization processes with various mixed metals.

iv) Initial Processing of the Precipitate

Set up eight PD-10 columns (Sephadex G-25M, GE Healthcare) and equilibrate each with 25 ml of 0.1M NaAcetate buffer pH 6.8 with 5 mM EDTA. This buffer is made by adding 5.4 gm of Na Acetate (trihydrate) and 770 mg EDTA (ethylenediamine tetraacetic acid) to 400 ml of dH₂0. Bring to pH 6.8 with additional acetic acid if necessary.

The product of the reaction is centrifuged 2 times at 1,000 g×10 minutes and one time at 1,500 g×10 minutes at 4° C. to remove particulates which are discarded in the precipitate after decanting the supernatant fluid after each of the three spins.

Apply 2.25 ml of black supernatant to each of the PD-10 columns. The EDTA buffers dissolves the unstable hydroxides, leaving only the stable ceramic spinel particles that are not readily dissolvable by the chelation buffer with EDTA/Acetate. Add 3-4 ml of the EDTA/Acetate buffer to elute the product. Some of the tail can be collected separately to assure substantially complete removal of the ammonia from the major portion of the eluant. In this fashion, free metal ions, particulates, ferrous hydrous oxides, chloride and ammonia are separated from the nanoparticle solution.

The PD-10 columns are washed and recharged with the EDTA/Acetate buffer and the separately collected “tail” of the eluant is run through to more completely clear this tail portion of the eluant.

Four of the C-100 or C-50 Centriprep centrifugal ultrafilters (Millipore) are cleared of preservative by putting 5 ml of dH₂0 in the outer chamber then spinning at 500 g for 5 minutes. All of the water is then discarded. The remainder of the ammoniacal black product is now applied to the re-equilibrated PD-10 columns, again as 2.25 ml aliquots, and then eluted with the EDTA/Acetate buffer.

v) Clearance of Unbound Dextran

The final eluant fractions are combined (approx. 30 ml excluding the ‘tails’) and brought to a volume of about 50 ml by adding fresh EDTA/Acetate buffer. The dilute product is then divided by pouring 12.5 ml into the outer chamber of each of the four C-100 or C-50 ultrafilters. The ultrafilters are assembled then spun at 500 g for 30 minutes. The transparent, reddish filtrate is poured off, and the four ultrafilters spun at 500 g for an additional 30 minutes. After discarding the filtrate, fresh EDTA/Acetate buffer (about 10 ml per tube) is now added to the black retentate fluid to bring each up to about 5 mm below the ‘fill line.’ Again, the four ultrafilters are spun at 500 g for 30 minutes, the filtrate decanted, and a second spin at 500 g for 30 minutes carried out.

vi) Filter Sterilization

The final retentate from the two concentrators (approx. 1 ml) is collected with a pipettor, combined and transferred to 0.22 micron centrifugal microfilters in volumes of 0.5 ml per microfilter unit. The microfilters are spun at 500 g for one hour. Alternatively, the final retentate from the Centriprep-100s or 50s can be collected with a 1 ml syringe, then passed through a sterile 3 mm diam. (low hold-up volume) syringe filter with 0.22 micron filtration. The purified, sterilized particles can now be stored at 4° C.

### B. Variations in the Precipitation Method

A variety of sizes of dextrans can be used, for example ranging from 1.5 K to 40 K MW although the 10 K dextrans have proven most reliable in these syntheses. It is also possible to coat the particles with latex or acrylic from for example cyanoacrylate monomers. Other coatings such as polylactic acid can be applied. A shift in average crystal core size towards smaller size can be produced by lowering the temperature of the synthetic reaction or elevating the pH. However, a variety of separation techniques may then be required to trim the size distribution to select the desired size range.

Additionally, the spinel crystal can be constituted of mixed metals in various amounts in order to achieve various specific optimizations. Mixed spinels including various useful transition series metals, and even some lanthanide metals can be made by adding the metal chloride directly to the saturated dextran solution prior to alkali precipitation. In all cases various isotopes that have useful beta (positron or electron) or gamma emissions can be introduced as their metal chloride or as a metal dissolved in hydrochloric acid in amounts varying from trace to full stoichiometric quantities

Specifically, for instance, the chloride salts of the metals with the positron nuclide at specific activities of 10-100 mCi/μM (370 MBq-3.7 GBq/μM) of 2+ oxidation state metal are dissolved in a supersaturated solution of 10,000 MW dextran in a ratio near Mt(II)1.0:Fe(III) 2.0 at a concentration of 0.5:1.0 molar and at a temperature of 20°-60° C. depending upon the final particle size distribution desired and the ferrites are precipitated by addition of 8% aqueous solution of NH₃ to reach a pH of 11 (about 4 ml added to 2 ml of dextran/metal salt solution), centrifuged at 1,000 g to remove particulates, separated and concentrated with a Centriprep-30 (Amicon) concentrator at 2,000 g for collection of small particles in the filtrate when desired.

The products of this concentration/separation step, either filtrate (reconcentrated with Centriprep-10 concentrator) or retentate, are passed through the PD-10 columns equilibrated with the EDTA/Acetate buffer as described above at least four times the volume of the applied sample in order to remove free metal ions, chloride and ammonia.

This desalted sample is again concentrated with a Centriprep-30 concentrator (2,500 g for one hour) to a 3 ml volume then passed through a 2.5 cm×25 cm column of Sephacryl-300 (GE Healthcare) equilibrated with EDTA/Acetate buffer with elution by 0.1 M NaAcetate/0.15 M NaCl buffer pH6.5 and 0.15 M NaCl to separate unbound dextran, and the resulting fraction concentrated to 4 ml with a Centriprep-30 concentrator (2,500 g for 15 minutes).

The resulting fraction can then be concentrated to a 1 ml volume with a Centriprep-30 concentrator for use or further subsequent concentration carried out when necessary. Reconstitution after freeze drying can also be used if desired.

The product of the precipitation reaction may alternatively be centrifuged 3 times at 1,000 g to remove particulates which are discarded in the precipitate. The resulting suspension is passed through the PD-10 columns.

This cleared and desalted product may then be concentrated with a Centriprep-100® (Millipore) ultrafilter or equivalent 100 kiloDalton membrane filtration system, at 1,500 g for two hours, resuspended and again concentrated to a 4 ml volume. This yields good clearance of particles below 5 nm and of unbound dextran into the filtrate for discard and this is a preferred method for the nanoparticulate.

Note that the susceptibility to concentration and dilution provides control over the density of the resulting solution or gel produced. Thus, depending on whether a longer distance of flight before annihilation is desired (use a low concentration) or a shorter distance (use a high concentration particles) an appropriate concentration can be prepared.

When only very small particles are desired, the initial concentration is done with a Centriprep-100 or 50 ultrafilter, but this filtrate is then processed further. This filtrate is reconcentrated three times with a Centriprep-30 ultrafilter to clear the dextran.

When primarily larger particles (in the 50 to 300 nm range) are desired, the desalted, ultrafiltered sample is concentrated with a Centriprep-100 concentrator or equivalent (2,500 g for one hour) to a 4 ml volume and then applied to a 2.5 cm×25 cm column of Sephacryl-400 R (Pharmacia) equilibrated with 0.1 M NaAcetate buffer pH6.5 with elution by 0.1 M NaAcetate/0.15 M NaCl buffer pH6.5 and 0.15 M NaCl. The resulting fraction concentrated to 4 ml with a Centriprep-30 concentrator (2,500 g for 15 minutes) for conjugation.

For some uses it is preferable for the particles to be less than 50 nm in diameter. Therefore, the Centriprep 100 product may be passed through first 0.2 micron and then 0.1 micron Nalgene® nylon microfilters. The resulting product is then concentrated to a 2 ml volume and applied to a 2.5 cm×50 cm column of Sephacryl-1000® (GE Healthcare) for size fractionation. Particles in the later fractions are collected for further processing. Larger particles will tend to produce shorter distances of positron flight before annihilation and vice versa.

Other variations concern the type of metal used in the particle or as the positron emitter. Where zirconium-89 is made by proton irradiation of yttrium, for a 3 day half life, various zirconium ferrites and other crystals and particle configurations would be used. The ⁸⁹Zr is made by an ⁸⁹Y(p,n)⁸⁹Zr reaction in a cyclotron. The ⁸⁹Zr is purified from ⁸⁹Y, ⁸⁸Y and other impurities by affinity chromatography on a hydroxamate column, with elution using 1M oxalic acid.

An example of a zirconium ferrite spinel nanoparticle synthesis from among those well known by those skilled in the art of mixed metal spinel ferrite nanoparticles synthesis, is the following from Yadav P., Faujdar A., Garathri S, and Kalainathan, S.: A Study on Nickel substituted Zirconium ferrite nanoparticles prepared by co-precipitation route. International Journal of Chemical Technology (ChemTech) Research 2014, 6(3), pp. 2181-2183, follows:

Ferrites nanoparticles of Ni_{0.5}Zr_{0.5}Fe₂O₅ can be prepared by coprecipitation method. The starting materials are Nickel chloride (NiCl₂.6H₂O), Ferric chloride anhydrous (FeCl₃), zirconium (III) chloride (ZrCl₃) of 99.999% purity and sodium hydroxide (NaOH), available from Alfa Aesar or other suppliers at analytical grade. Polyethylene glycol-400(PEG-400) can be used as a surfactant. The molarity of the coprecipitation agent (NaOH) should be 3 mol/l. The solution of CoCl₂.6H₂O, FeCl₃, ZrCl₃, in their stoichiometry (100 ml of 0.1M NiCl₂.6H₂O, 50 ml of 1.4M FeCl₃, 50 ml of 0.6M ZrCl₃, in the case of Ni_{0.5}Zr_{0.5}Fe₂O₅ and similar for other values of x and y in NiₓZr_{y}Fe₂O₅) are mixed in double distilled de-ionized water. The salt solutions were mixed together with continues stirring. The neutralization is carried out with NaOH solution, and the pH is maintained around 12. A few drops of PEG-400 are added to the precipitate and heated at 80° C. using a hot plate with continued stirring for 2 hrs. The resultant precipitate is then cooled to room temperature. The precipitate is then washed and filtered several times with deionized distilled water. The precipitate may then be dried at 100° C. for overnight. The dried sample is then sintered for 5 hours at 500° C. After sintering the sample can be subject to grinding using a ball milling apparatus. The resulting powder sample can be evaluated using X-ray diffractometry, scanning electron microscopy and transmission electron microscopy characterization.

When nickel is omitted, the result will be ZrFe₂O₅ nanoparticles. Where the dextran solution and ammonia precipitation is used as for the ferrite particles described earlier in the application, the result will be nanoparticles suspended in aqueous solution.

### 8. Liquid Conductors

A. Accomplishing Multiple Tasks with Liquid Conductors

In some applications, mercury fluid will provide a good medium because it is both a high Z-number material (Z=80) which provides a beneficial situation for photoelectric and Compton effect interactions that can move electrons into the conduction band and are also liquid conductor that can both allow the passage of nuclide carrying particles and conduct the electrons emitted in photoelectric interactions. Mercury has an electrical conductivity of 1 Siemens/meter×10⁶ which is about 1/60th the conductivity of silver—the best metallic conductor, but more than a million times the conductivity of many aqueous electrolytes.

Although with a somewhat lower Z-number, a eutectic alloy of gallium is also an effective medium for photoelectric trapping of high energy photons in this system. One example of such an alloy is gallium at about 68% weight, mixed with Indium at 22% weight and Tin at 10% weight. The respective Z-numbers are Ga-31, In-49 and Sn-50. The conductivity of 3.46 S/m×10⁶ is better than mercury. It is capable of dissolving other high Z elements into the liquid although it will not dissolve in aqueous or organic materials. It is made by heating the three elements to their melting points—Tin-231° C., indium-155° C. and gallium 28° C. The term “eutectic” means the melting point of the alloy (here −19° C.) is lower than the melting point of any of the components.

A higher average Z-number can be obtained by adding lead (Z=82) or bismuth (Z=83). Bismuth also has two positron emitting isotopes—²⁰⁷Bismuth has a half-life of 33 years while ²⁰⁸Bismuth has a half life of 36,000 years. Therefore, ²⁰⁷Bismuth is a suitable ‘positronic battery’ nuclide for interplanetary spacecraft. An alloy of 66% weight Indium with 34% weight bismuth has a melting point of 70° C., but lower melting point Bismuth Mercury alloys would also be suitable for spacecraft.

The advantage of a liquid conductive high Z-number photoelectric trapping medium such as GaInSn is that there is a uniform density of 6 gm/cm³ which is greater than the density in a spinel ferrite (5 gm/cm³) and greater than the density of a typical garnet (3.6 gm/cm³) but much greater than the density of an aqueous electrolyte (1 gm/cm³).

The use of a conductive liquid for this task greatly simplifies the problem of capturing electrons wherever they may be generated as the high energy photons travel through the medium, experiencing photoelectric interactions, and reemerging with progressively lower energies or being replaced by emitted photons of lower energy.

### B. Conductive Environment

The use of junctions in Group IV semiconductor silicon, positive doped using Group III elements (such as boron or aluminum) and negative doped (using Group V elements (such as phosphorus or arsenic) leads to “p-n junctions” in which directionality and conductivity are provided by the dopants. A layer of n-type semiconductor bearing extra electrons is closest to the incoming photon source, but is placed directly onto a layer of p-type semiconductor with extra holes, that is itself adjacent to a conducting electrode. As new electrons are ejected from the atoms or as they are shifted into the conduction band by excitation from the energy imparted by arriving photons, the displaced electrons in the n-type semi-conductor tend to flow towards the positively charged “holes” in the p-type silicon. This establishes a directional current which carries incoming electrons arising with photovoltaic effects toward the p-type section and across this thin layer into the conductive copper electrodes.

In the positron annihilation vessel, a lining of rigid or flexible film p-n junctions, as well as an imposed directional voltage imposed across the conducting GaInSn fluid, can cause electrons to generate a directional current into a circuit bearing resistive load.

Directional flow of electrons can be supported by emplacing non-conductive plastic channels and tubes so that a return part of the electric circuit can be placed distally in the vessel while an output common electrode can be placed proximally with achievable isolation between input and output that requires electrons to flow directionally in the circuit.

### C. Flow Arrangement for Positronic Fluid

The positronic fluid may be conducted in an array of connected, branching, flexible, replaceable silicon or plastic tubing either with linear elements or with numerous loops and coils so that the positronic fluid can be pumped into the channels. The tubing incorporating the positronic fluid can be lowered into what is in effect a bath of GaInSn electron source fluid (ESF) that can moderate and degrade the high energy photons into low energy photons, continuously withdrawing electrons that are made available as the process continues. The tubing can be of various diameters or rigidities, can be substituted with thin films, sheets with perforations to allow passage of the ESF through its interstices or in a wide variety of other arrangements. This complex sub-vessel containing the positronic fluid can be lowered into the ESF bath or it can be left in place whereby fresh positronic fluid can be pumped through it periodically. When a very long half-life positron emitter is used, it may be more convenient to use design in which the tubing will stay in place or possibly hold only a single charge of positronic fluid. When very short half life emitters are used (minutes or seconds) then continuous flow apparatus and pumps will be more effective.

### D. Wire Based Arrangement

A simpler and more conventional arrangement is achieved when the vessel is filled with an array of insulated copper wires or higher Z-number wires such as silver or iridium wire, laid down in parallel to each other, terminating progressively into the output and arising from the input. The positronic fluid is then pumped into the interstices between the wires or through hollow tubing placed among the wires. In this arrangement, there is no need for a semi-conductor lining and no need for the GaInSn electron source fluid. Photoelectrons and Compton electrons generated by impacting photons are directly extractable by application of a voltage along the wires.

### 9. Positron Based Fluidic Systems for Power Generation and Utilization

### A. Superparamagnetic Positron Emitter Motor

As an example of the utility of mixing the capabilities of superparamagnetic fluids with positron emitting fluids the inventor provides a description of system and device that provides a new type of motor. This device is based on an array of a large number of very small unit elements. The elements are linked to each other along a strand line. A given motor may have multiple parallel dynamic strands of this type.

The strand is capable of shortening as the motor elements are operated. The various strands are attached to an anchor at one end and a base another end where in the base and anchor accommodate differences in contractile status between parallel strands. In one version a strand passes around a simple pulley at each end so that contractions in parallel strands are effectively shortening a single strand that has multiple turns. Alternately, an advanced electronic control system—described below, can coordinate movements among separate parallel strands.

The shortening or contraction at each active element involves a piston within a small metallic conducting coil. When electricity circulates in the coil it generates a magnetic field along the center axis of the coil. Circulating into the coil space is a superparamagnetic fluid of the general type described by Filler in U.S. Pat. No. 6,562,318.

A superparamagnetic nanoparticle has a powerful magnetic vector, however, the particle size is smaller than the size of a single magnetic domain for the given type of material. In this setting, the direction of the magnetic field vector in the nanoparticle—for instance a spinel ferrite—flips into different orientations at a very high rate—many thousands or millions of times per second. The result is no externally detectable magnetic field and no magnetic interactions with surrounding similar particles or materials. However, when an external field is applied, the vector field direction settles into alignment with the surrounding magnetic field. Abruptly, all of the particles in the field settle with parallel direction of their vectors. When this occurs, they begin to exert magnetic interactions with each other.

When the spinel ferrite nanoparticles are coated with a material—such as dextran for aqueous solutions or any one of numerous types of coatings well know to those skilled in the art of soluble nanoparticles—the magnetic activation of the particles in the fluid has an unusual effect on the general properties of the fluid in which the particles are solvated. The magnetic attraction among the solvated particles does not overcome the solvation—that is, the particles remain in apparent solution—even when centrifuged at high speed the particles remain solvated.

However, the application of the external magnetic field causes the fluid to have an abrupt increase in apparent density. An example of this phenomenon was carried out by the inventor as follows. A test tube was filled three quarters full with a high concentration aqueous superparamagnetic fluid. A smaller diameter plastic capped plastic test tube was filled with mercury and sealed. The tube of mercury was dropped into the superparamagnetic fluid and sank because mercury has a much greater density than water. An external magnetic field was applied and this caused the tube of mercury to rise and float with more than half of its linear extent in the air above the top level of the superparamagnetic fluid. In this situation, mercury becomes buoyant and floats on water because the magnetic effect of the solvated particles acting on each other, causes a large increase in the apparent density of the aqueous solution, expelling the much denser mercury. Much of the energy for the effect comes from the intrinsic magnetism in the nanoparticles.

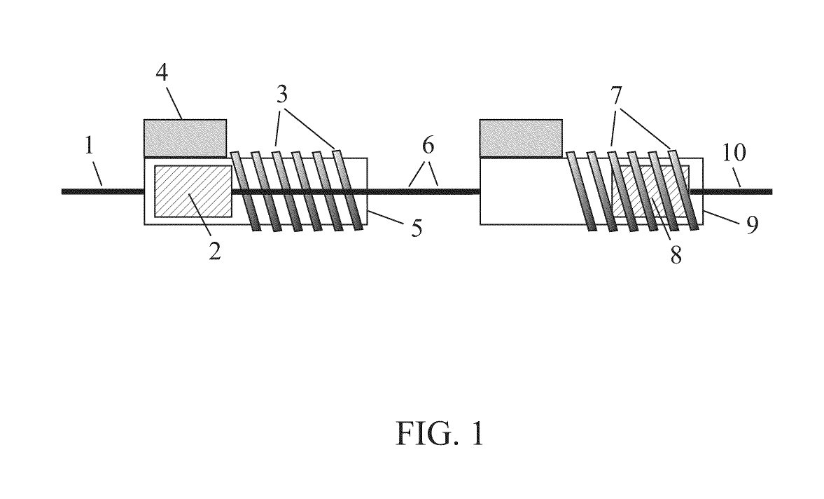

In the motor described here, this phenomenon of changeable apparent density is used to drive a piston out of a region of magnetized fluid (see FIG. 1). In FIG. 1 the piston device includes a connecting fiber 1 along which the piston subunits travel when the piston is expelled, a piston 2 containing low density material similar in density to the aqueous solution containing in which the superparamagnetic particles are dissolved, a solenoid 3 disposed in the wall of the piston chamber, an electric and electronic unit energy and control unit 4 for the capture of positron energy by photovoltaic effects, with microelectronics that control the piston assembly by both receiving control information from a central processor and providing information on its own position back to the processor. The piston chamber 5 is variably magnetized by the solenoid causing the piston to move the device along the connecting fiber 1, 6 and 10. A similar second set of a solenoid coil 7, piston 8 and chamber 9 is shown on the right but with the solenoid not activated so that—unlike the piston on the left, this piston has not been expelled from the solenoidal portion of the piston chamber by magnetization of the superparamagnetic fluid within it.

This small device—for instance 5 millimeters in total linear extent has an open chamber with a piston. when the coils is electrified, it creates a magnetic field that settles the intrinsic field vectors in the superparamagnetic nanoparticles, driving the piston out of the part of the cylinder that has the electrified coil. The piston is connected to a the next device in line by a fine nylon thread. Dozens of such units can be in line along a thread. When the coils are electrified, all of the pistons are expelled and the nylon lines shortens as the cylinders are driven into the non-coil portion of the chambers.

Alternately, the units can be embedded in a web like gel and can exert their motive force in a more generalized manner.

Each motor unit includes microelectronics capable of receiving radiofrequency or optical signaling and capable of detecting its own orientation and position in space relative to a “frame of reference” skeleton of the device. Each unit has a unique identifier address. In this way, an overall controller can activate whatever addressable motor units that are needed to effect a movement and can detect the position of each unit as well as the position and length of the threads and skeletal elements of the entire device. In addition to being able to identify their precise three dimensional position in space and transmit this information—in secure encoded form—to the central controller as well as receive direction to activate the coil electric flow and to vary the current, each unit is also fitted with photovoltaic and Compton effect material to make them capable of employing collisions by photons to generate electricity to use to power the coils and the communication and positioning electronics.

Such a system can be conceived of in the form of a robot. The groups of coordinate contractile units are analogous to muscles—agonist and antagonist—across the various joints of the robot.

The supply of power to the individual units is derived from photons generated by the positron emission and subsequent annihilation throughout the robot. Each synthetic muscle group is a compartment that is connected by tubing that can be opened and closed to replace and refresh the fluid as needed to provide freshly charged positronic superparamagnetic fluid. This fluid is thus capable of generating power through photon generation, absorbing photons to produce a photoelectric, photovoltaic or Compton effect, and also acting as the superparamagnetic drive for activating the pistons to provide contractile force.

Mirroring material in the inner surfaces of the muscle like units will reflect lower energy photons back toward the synthetic muscle. This acts like an energetics filter because higher energy photons will pass out of the inner envelope into a zone with a high Z-number fluid for electron production with subsequent higher Z-number mirroring using high Z-number mirroring materials external to the high Z-number fluid layer.

Alternately, pistons can be arrayed around a cam shaft as is done for an internal combustion engine so that coordinate activation of the solenoids to drive the pistons will provide a powered rotation of the shaft where this type of movement is required by a particular device thus constituting an internal annihilation engine.

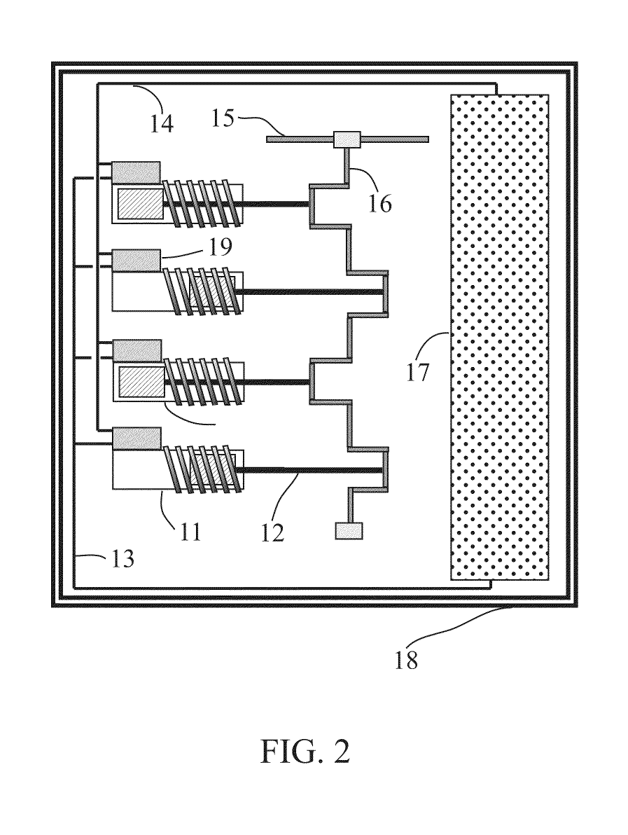

For very small engines, optionally, the annihilation, any pair production chain reactions, and photoelectric effects take place in a separate chamber wherein a voltage is applied across the reaction chamber so that conductors at either end can carry a generated electric current to apply to the piston chamber solenoids (see FIG. 2). In FIG. 2 the diagram shows the piston chamber 11, the piston rod 12, the electrical conductor output carrying a current of electrons 14 into the power and control units 19 and then out of the units by a conductor 13 to return to the annihilation and photovoltaic region 17. As the control units activate the pistons, the piston rods rotate a cam shaft 16 to drive a wheel 15 to provide mechanical rotatory force. The outer wall of the engine 18 provides shielding for stray emitted gamma rays and high energy annihilation photons.

For larger engines, however, the superparamagnetic and positron carrying fluid can be introduced directly into the piston chamber—which is lined by a low density insulator—wherein the annihilations substantially take place in the piston walls with conduction of the electrons into the solenoids of the piston under an applied voltage by means of conducting wires and under control of a microelectronic control unit affixed to each piston. The piston walls get depleted of electrons and excess electrons arise in the fluid. A separate conduction from the fluid to the piston wall will assure charge balance and this current may also be used for operation of the engine.

### B. Introducing & Removing Fluid Components for Variable Shape

As can be seen in the example above, among the important advantages of using fluid media for the positron source, high energy electron source (β⁻ particles), and for the positron absorbing medium is the ease of development of systems of complex shape that convert light to electric energy at numerous sites throughout the device. This consideration applies for both solvated nanoparticles, chelation solutions, and for simple aqueous solutions of dissolved salts of relevant nuclides. In addition, both the source and absorber are capable of flexibility during movements of the vessel.

One type of complex vessel is described above by the inventor as a system providing robotic functions, built to follow the general shape, size, structure and motions of a human with the vessels separated in the shape of muscles with similar paired functions of driving flexion, extension, twisting and bending across joints. However, this is just an example and the inventor considers this to be a preferred embodiment wherein other types of system employing these principles include for instance a three dimensional design system in which a mass can be directed to assume various shapes under control of three dimensional rendering tool. Similarly the system could provide a reshapable internal and external mold—under dynamic control from such a rendering tool so that the mold could be used for casting materials into complex shapes. Another example would be the formation of structural elements such as small bridge—as during an flood or other emergency where the material in large container could be directed to form into such a bridge shape over a stream to support the passage of persons or vehicles after which the shape would be released and the fluid drained for storage for use at another location. These are just a few examples of the use of a controllable powered liquid system capable of accomplishing the formation of various shapes under electronic control.

Most important in addition to the potential for mechanical flexibility is the potential for recharging or replacing the positronic fluid as its supply of positrons becomes exhausted. The inventor considers that the fluid containing the positrons could be removed and reprocessed. The iron could be used in ⁵²Fe isotopic based production to form new ⁵²Mn. The particles can also be dissolved in acid, precipitated, centrifuged and cleaned to form raw materials for the manufacture of new nanoparticles incorporating positron emitting metals freshly activated in the cyclotron component of the system.

Even when recharging of the fluid is not required, the fluid can be removed for storage in the interior of a storage unit capable of allowing disintegrations to progress in the presence of an insulator such as silicon dioxide sand so that undesired build of electric charge could be avoided.

Then, when the development of electric current is again desired, the fluid could be reintroduced into the presence of the conducting absorber material.

Using a fluid based absorber material can provide a similar degree of mechanical flexibility when useful and desired such as in the robotic synthetic muscle configuration discussed above.

### C. Change of Fluid State in System Manufacture

In some uses, it will be desirable to use a less flexible gel structure. This may be the situation where a long half life positron emitter is chosen. The fluid medium carrying the nanoparticles suspended in an aqueous or non-aqueous fluid can be mixed with unpolymerized components of materials capable of polymerization. An example used by the inventor in Filler U.S. Pat. No. 6,562,318 or U.S. Pat. No. 6,919,067 is the components of polyacrylamide. Once gelation is accomplished, the particles become fixated in position in the gel matrix. This type of liquid to solid transition can be accomplished in many ways. The nanoparticles or even finely ground positron source material—such as finely ground manganese containing ⁵²Mn—can be mixed into molten metals or glasses that are then allowed to cool in various forms. Where the resulting solid is a metal, application of voltage can be used to cause electrons dislodged by photoelectric or Compton scattering effects to be collected for use as an electric current. Where the medium is an insulating material such as a glass, the emitted photons will still be readily usable as they travel into adjacent absorbing materials to cause electron release. Where a molten semiconductor such as silicon is used, there may also be subsequent doping to develop P and N components so that electrons and excitons formed in the semiconductor medium can be allowed to flow across PN junctions for collection on electrodes that are components of circuits with resistive load. Positron emitting semi-conductors can also be fabricated using gallium arsenide, where ⁷⁴Arsenide (T_{1/2}=80.3 days) is incorporated with stable ⁷⁵Arsenide. Using a bimetallic surface may also be similar to a P-N junction in a semi-conductor where a metal with more empty valence shells is analogous to the semi-conductor doped with holes.

This type of fluid state conversion therefore includes the use of catalysts, precipitants, heating or cooling, hydration, dehydration, magnetization or even sonic or shock wave based methodology to alter the state of the medium. Very high pressures, ultrasound cavitation or even high explosives can be used to change some carbon media into diamond. Carbon nanotubes, fullerenes and graphene can be formed in various shapes using arch discharge, laser ablation, plasma torch, and chemical vapor deposition. Formation of carbon nanotubes in conductive absorption medium can increase the electron transport capability of the medium. However, formation of these structured materials in a liquid vehicle carrying positron emitting nanoparticles can be used as a form of gelation as well.

### D. Gaseous and Liquid Positron Emitters

In still other situations, a gaseous emitter such as ⁷⁹Krypton which has a 1.5 day half life (T_{1/2}) (produced by neutron irradiation of ⁷⁸Kr). Use of an inert gas as a positron source is convenient for introducing, removing and replacing the source. This would be most advantageous for low power applications since it is difficult to achieve high concentrations of a gas. The positron emitting nuclides of fluorine-18 (T_{1/2}=1.8 hours), oxygen-15 (T_{1/2}=) and nitrogen-13 (T_{1/2}=10 minutes) are useful as medical tracers but generally have too short a half life for many of the application disclosed in this specification.

An intrinsic, elemental liquid positron emitter such as a mercury isotope ¹⁹⁵Hg (T_{1/2}=10 hours) (produced by, for instance, cyclotron treatment of gold-197 for proton neutron exchange, or by spallation of lead or bismuth in a linear accelerator) can be used. However, this is essentially the only choice for an positronic liquid that can be used immediately upon formation.

### 10. Positronic Systems for Elaboration of Electrical Effects

### A. High Voltage Electrodes and Field Emission

The acceleration of an electron in an electric field results in the introduction of kinetic energy based on the potential voltage and is not affected by the distance of travel of an accelerated electron. A one thousand volt potential difference will accelerate an electron at rest to have a kinetic energy, in vacuum, of 1 KeV. Therefore, to add the minimum of 511 keV of kinetic energy to a lepton, we need an electric field arising from an electrode at 511,000 volts. With this field in place, an electron undergoing annihilation will have its rest energy of 511 keV plus a kinetic energy of 511 keV and there will be similar energies in the positron. The total energy at annihilation will be 2.044 MeV and this will be conserved. Where two annihilation photons result from the matter anti-matter reaction, each can have an energy of 1.022 MeV—sufficient to cause pair production.

When an electrode is raised to a voltage of 511 keV, it is not necessarily sufficient to just add charge with capacitors and to maintain the voltage without adding additional energy. This is because of the field emission that takes place—at high voltages, electrons will be ejected from the negative potential electrode and will travel to the positive potential electrode. The result will be the progressive elimination of the potential difference until the voltage drops below the amount needed to produce field emission in the material used. The problem can be dealt with by incorporating a circuit so that emitted electrons can be returned to their source cathode.

Emission of electrons is desirable in an electron gun configuration where the phenomenon can be employed to produce a stream of high energy electrons. That can be done in the setting of this invention, but this will not take advantage of the significant kinetic energy of emission where a beta (minus) emitter is used as the electron source.

In a concentric electrode, it is possible to accumulate the electrons on the outer circumferential electrode without forming a countervailing electric field. Choice of materials for the electrode to minimize field emission also reduces the energy required to maintain the high field. The electron work function of various electrons measures the work required to remove an electron from the surface of an element and is described in Φ/eV. For polycrystalline lithium this is 2.93, for copper it is 5.1, and for platinum it is up to 5.93. This varies with degree to which the surface a material is smooth and clear of particles, because a rougher surface tends to concentrate the electron moving force at a greater force per unit area in a field.

Additionally, with a β⁻ emitter adjacent to the negative electrode, a certain number of electrons from the emitter will enter the electrode to replace those lost by field emission.

### B. Annihilator as Electrical Component

Analogous to the capacitor or resistor in an electric circuit, it is useful to place an “annihilator” in an electric circuit. This is a device that destroys electrons. When placed in an open circuit with an electrode attached at either end, and an ultra high voltage thyristor (e.g. silicon carbide) that allows only unidirectional flow of current it creates a battery charge function.

An annihilator is a two component circuit element with a conducting element joining the two components. The first component contains a positron producing emitter nuclide content in a linear cylinder of arbitrary length, e.g. about two centimeters and a diameter of three to five millimeters. At one end of the cylinder a conducting wire is attached. This emitting rod is surrounded by an insulator, optionally containing a vacuum component. There is then a hollow cylinder fitted around the outer surface of the emitting rod insulation. The wall of body of the hollow cylinder is about five to ten millimeters in thickness and this serves as the annihilation zone of the device. A wire connects the emitting rod to a load and then the wire continues on to reach the annihilation zone cylinder.

In operation, as positrons are formed and emitted from the emitting cylinder, they leave the cylinder with the force of their emission due to nuclear disintegration. In the emitting cylinder, with each such disintegration, the nucleus of one atom changes from a proton to a neutron so that one less electron is required in the atom. Thus, as the positron departs the physical substance of the emission rod, an excess electron becomes available in the rod and the rod achieves a negative charge.

In the annihilation cylinder surrounding the rod, the positron arrives, loses kinetic energy, and undergoes annihilation. Once the annihilation has taken place, the annihilation cylinder is depleted of one electron and becomes positively charged.

Considering that following a sequence of disintegration and positron emission in the rod with subsequent annihilation of the positron and an electron in annihilation cylinder, there is an excess electron in the rod and one less electron than what is needed in the annihilation component. Therefore, a current is established in which an electron flows from the area of electron excess (the emission rod) to the area of electron depletion (the annihilation cylinder).

A comparable sequence of events occurs in a system of similar design containing a β⁻ emitter. In the electron creator component, when an electron is emitted from a nucleus in the emission cylinder, a neutron becomes a proton. Once this occurs, the emitting material becomes positive in charge and there is a need for an electron created. When the emitted beta particles reaches the surrounding accumulation cylinder, that cylinder acquires a negative charge due to the introduction of an excess electron. Where a conducting wire joins the emitting rod to the accumulating cylinder, a current will be established so that electrons can flow from the area of excess in the cylinder to the area of depletion in the emitting rod.

To the extent that that either an annihilator component (or similarly an creator component) is formed with a fixed amount of emitter, the amount of the resulting current in milliamps will be dependent on the amount of radioactivity present in the emitter at the start. As half-lives progress, the current will steadily decrease. As to voltage, this will depend upon any delay in opening the circuit. If no current flow is permitted, the charge difference between the emitter and annihilator (or accumulator) will increase steadily in an amount proportional to the amount of emitter in the emitting rod. If a current flow is then allowed, there will be a voltage difference dependent on upon the rate of flow of electrons allowed in the circuit, and the rate at which beta particles are emitted.

These components may be made into stable sources of current or voltage if the central cylinder is actually a flow chamber. Here, there is an inflow of freshly charged emitter and an outflow of relatively depleted emitter. This flow can be sustained in a sufficient rate and volume as to keep the current and voltage within desired parameters.

The voltage and current can be held relatively constant where the fluid is progressively concentrated in centrifugal ultrafilters after each pass so that the a an approximate selected specific activity can be sustained by progressively concentrating the particles as they progress through their half-lives.

This is not either a static field arrangement nor is it a conventional electric circuit. In a standard matter electric circuit, the current must flow back to it's source or to ground. In general though, there would have to be an additional connection from the annihilator component back to the creator component to have a circuit. This is true in standard matter electricity systems, but it is not true for a matter-anti-matter circuit, or for any circuit in which leptons are produced or destroyed by β⁻ or positron emission arrangement described above in this section. Although matter, energy and charge are ultimately conserved, an electric system including a β⁻ emitter creates new electron from other sub-atomic particles while in a standard circuit, electrons are relocated, or caused to have increased or decreased kinetic energy, but they are never created or destroyed.

Similarly, in an electric system including a positron emitter, the operational process is the destruction of electrons. Positrons are created from other sub-atomic particles, but these are not significantly subject to electric flow when they are introduced as anti-matter into an environment that is vastly suffused with matter. This is the condition inside an environment such as a ferrite nano-particle or inside a solid metal conductor. High energy photons are created when the mass of the electron and positron is abruptly converted to energy—but these high energy annihilation photons are able to leave the system to be absorbed and have their energy exploited in an entirely separate part of a device. This is different from what takes place in a conventional photon emission circuit such as a light bulb because those system convert a high energy electron to a low energy electron—releasing the energy as light—but do not eliminate or destroy the energy carrying charged electron.

For these reasons, a system that employs lepton generation or destruction that is designed to perform electric work need not be deployed as part of an electric circuit, nor need it be restricted to static field generation. Rather, it may also be organized as what will be called—on a lexicographical basis here—an “electrical stream” as opposed to an electrical circuit. An electrical stream, in this patent, is used to describe a novel type of connected electrical system that includes either or both of a β⁻ emitter and/or a positron emitter. When either stream component is present by itself or when both are present, a non-circuit can be used to cause electrons to flow and do work. An electrical stream is also different from a circuit in that whether a β⁻ emitter, a positron emitter, or both are incorporated, the flow of electrons in the stream is towards the annihilation cylinder of the positron emitting device or away from the β⁻ absorber of the β⁻ device. This directionality is not reversible in the form of a simple stream—that is a stream that has an electron annihilator device, an electron creator device or both, and in which the only other components are devices that extract/release energy for work (light bulb, microprocessor, etc,) or which provide control such as a voltage regulator or switch. For linguistic simplicity, again on a lexicographic basis, in any system connected with conductors or semi-conductors that incorporates β⁻ emitter, positron emitter, or both, of those components, the annihilator component and the creator component will be termed “delta-lepton” components or devices.

The energy budget of the phenomenon for a simple delta lepton component is determined by the theoretical maxima. The synthesis of zirconium-89, for instance, from yttrium by proton bombardment, is followed by chemical separation of the ⁸⁹Zr from the parent Yttrium or other elements, so that at the outset it is possible to prepare a block of ⁸⁹Zr that is greater then 99% ⁸⁹Zr. If every single atom underwent a disintegration with positron emission followed by annihilation inside the volume of the annihilator cylinder component, then there would be a deficit of electrons equal to the number of atoms. If we consider the situation with one mole of ⁸⁹Zr, this will have 6.022×10²³ atoms and will weigh 89 grams—about 70% of the weight of standard “D” battery. The charge of each electron is 1.60217×10⁻¹⁹ coulombs. We therefore have one mole of lost electrons with a charge of 9.62×10⁴ coulombs. We can then compare the 100,000 coulombs of charge in the 89 grams of ⁸⁹Zr to the number of coulombs in a fully charged D battery weighing 144 grams—about 13 coulombs (generally described as 13,000 milliamps/hour) where a standard load of 130 milliamps will discharge the battery fully in 100 hours. Thus, a lepton battery can store about 10,000 times the charge of a standard alkaline Zn/MnO₂ (“energizer” TM Energizer Holdings Inc.) battery. An advanced high storage lithium battery can have up to twice the storage of an alkaline Zn/MnO₂ battery, but this is still 5,000 times less dense potential storage than this lepton system.

At the end of the discharge period, the lepton battery would not be rechargeable, but there would be no remanent radioactivity. This analysis completely neglects the extractable energy in annihilation photons that are produced during the process. Each annihilation converts matter to energy—a million electron volts in the two annihilation photons—so that photons carrying 1.022×10⁶ eV are emitted with each of the 6×10²³ annihilations. This is 6×10²⁹ electron volts of exploitable annihilation energy from the mass to energy conversion reactions quite aside from the battery function energy from the electrical flow effects of the destruction of the electrons. Generally, the energy in the gamma rays is simply wasted, but this invention—in it's other sections—describes the methods for extracting usable electrical energy from the gamma rays. In a solar cell, it takes about 3 of the sun's 1 eV photons to release an electron. So the electrons that can be used as a power source from successful complete exploitation of the annihilation photons from the battery would be at least up to 10²⁹ electrons. One ampere of electric current is 6.241×10¹⁸ electrons per second, so this is in the range of 1×10¹¹ or 100 billion amps.

The limit of positive charge that can be reached in an annihilator component will result from exhaustion of the positron emitting nuclide atoms in a material, but where sufficient emitting atoms are present there will be bulk considerations in matter that do not apply to the conceptual isolated atom disintegration situation. In a solid, self contained mass of pure material composed of a positron emitting nuclide in which every atom is destined to emit a positron, it is still the case that only one electron can be destroyed for each atom in the bulk material. This is unlikely to result in a significant alteration of the integrity of the material or to produce positive electrostatic field forces within the material that could be counter to or prevent the forces causing the disintegrations that release positrons.

However, if a positron emitting fluid is flowed through the annihilator rod position then positrons will emerge from the fluid, pass into the annihilator material, and undergo annihilations in the annihilator that remove electrons from it. This configuration can be called an “augmented annihilator” meaning that the component involves the introduction of positrons from a source outside of the conducting electric stream and from a source volume outside of the annihilator itself. This allows for far greater packing of positive charge into the target—reaching a far greater charge density than is ever present in the positron source fluid. It is nonetheless required for the electric stream that excess electrons becoming available in the source fluid as the positron is emitted and a proton turns into a neutron are extracted. This generally can be accomplished by having a wire or some similar conductor connected to an electrode in the wall of the tube through which the source fluid flows. Thereby, as the excess electrons become available they can move electrostatically along the wire to reach the positively charged annihilation cylinder more easily than reaching it by crossing the insulation that separates the cylinder from the central rod volume.

The flow of electrons in the stream can be used to turn an electric motor, act as a battery charger or do any other routine task carried out with a current, although in this arrangement the electromotive force is a nuclear disintegration. In another configuration the annihilator causes a high voltage positive charge to form on a positive cathode plate and this applies an electric field to an adjacent plate that is used as a field effect electron emitter to cause electrons to flow in a beam for use in annihilation reactions.

Use of an electric stream from an augmented annihilator or augmented creator component is a particularly useful method of providing for battery recharge for several reasons. Firstly, it is possible to build up large voltages to rapidly recharge a battery without providing electricity or burning other fuel at the recharger location. For electric automobiles needing distributed charging stations for rapid recharging, this type of system is well suited. There will also be good uses for military applications such as advanced robotics or energy beam projectors, as well as for long distance space craft. Selecting an appropriate nuclide will determine the half-life thus setting the rate of release of energy. The effectively full depletion of ten half lives (99.9% consumed) could take place in an optimal selected time interval ranging from minutes and hours at one extreme but also on up to thousands of years depending on this choice.

Using this type of positron based high voltage generator, the very high fields required for acceleration of positrons and electrons to achieve pair production become possible without requiring any additional energy input besides the positron source. The positrons in the electron sink will continuously destroy electrons by annihilation. The electric field positivity in the medium in which the positron annihilations are taking place should reduce the distance of travel of the positrons before annihilation but should not stop positrons from entering the sink. Note that a field strength at or in excess of 511 thousand volts positive on the isolated positron generated electron depleted positive electrode and at or in excessive of 511 thousand volts negative on the isolated electron accumulation electrode enriched negative electrode (β⁻ emitter system) will provide the necessary field strength potential difference to accelerate the positrons and electrons to achieve chain reaction energies for pair production.

Very high concentration of positrons is required to actually cause field emission of positrons and should only take place one most conduction band electrons are consumed. Operationally, the disintegration energy provides sufficient kinetic energy to the positrons to emit them from the surface of a positron emitting surface but positron field emission is unlikely to occur in any setting because of the vast preponderance of matter relative to anti-matter in the known universe. This differs from the situation of a similar configuration established to generate high voltage in an electron creator arrangement with a β⁻ emitter because the target will be subject to field emissions that sharply limit the ability of the system β⁻ system to generate high voltages.

### C. Positively Charged Source for Stable Electric Field

Presently, in the subject are of obtaining work from electric fields, the use of electric current plays a major role. In such an arrangement, electrical energy delivered by a current of electrons at elevated potential energy is employed to increase and maintain the voltage by extracting that potential energy of the electrons in the current. Energy is expended for this task and the electrons change from a high energy state to a low energy state when work is done by the current acting upon a load. Then external energy is used to restore the high potential energy of the electrons in a repeating cycle.

There is very little use of pure electric field sources—with no supportive electric current—for the purpose of doing work. One example of a device that produces a high static electric field is a van de Graaff generator. In this device a physical pulley is used to push excess electrons into an electron sink, so that a progressively high voltage develops from the excess electrons. As the field becomes stronger and stronger with more negative voltage, two problems limit the maximum charge of the field and destroy its stability. Firstly, it becomes more and more difficult to introduce more electrons because the negative electric field repels incoming electrons. Secondly, as excess electrons accumulate in the electron sink, field emission commences—the lightning-like sparks that shoot out into the air around the metal sphere of the van de Graaff generator. This limits the charge to about 5 megavolts in air and about 25 megavolts when the target material is surrounded by pressurized insulating gas.

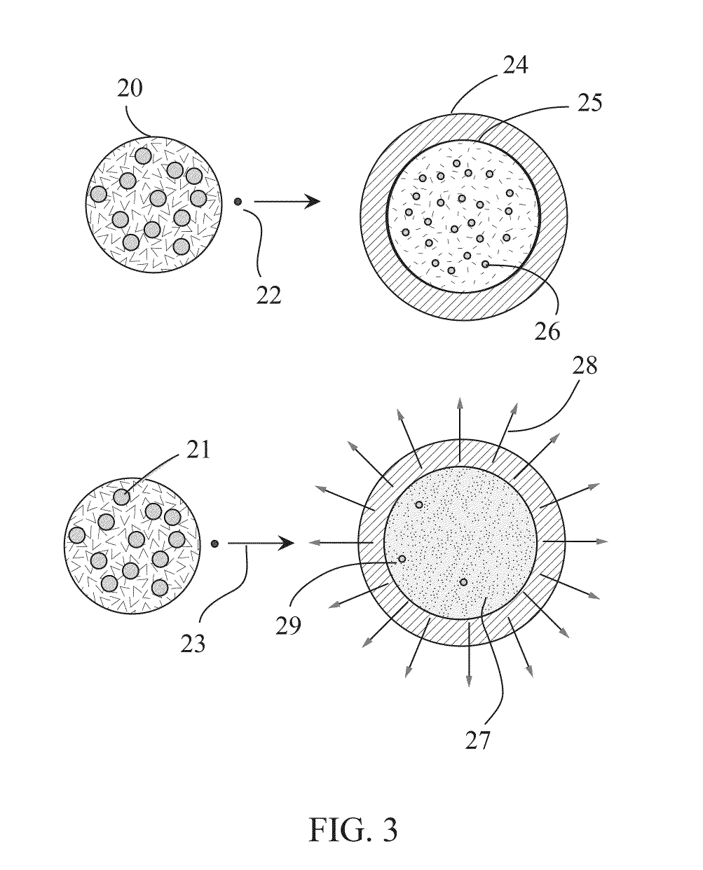

In the new invention, the inventor has conceived of a positive electric field with very different properties, different formation issues, and a very different stability paradigm. A conducting target material—such as ferrite spinel material—is completely surrounded by thick capsule made of a low density but highly insulating material such as polycarbonate that can be cast formed around the target material during manufacture. A fluid stream carrying dissolved spinel nanoparticles—or chelation carriers like EDTA, NDTA or DTPA of individual atoms—with a positron emitting nuclide such as manganese-52 incorporated provides a source positrons. The positrons are emitted in a highly energetic state from the nuclear disintegration and pass through the low density insulator to reach the spinel core where the positron slows, collides electrostatically with an electron and causes the electron to be annihilated (see FIG. 3).

In FIG. 3 we see on the top of the figure the charge balanced carrier fluid 20 incorporating particles 21 with positron emitting nuclides. A positron emitted with very high kinetic energy departs from the carrier fluid 22 and then passes through the cast capsule of low density, highly insulating material 24 to reach the conducting core 25 where it will annihilate an electron 26. After the elapse of time, successive arrival of positrons will continue because the force of the nuclear disintegration 23 will continue to hurl positrons into the positively charged core until the positive electric field strength 28 reaches very high levels as that core becomes progressively depleted 27 of electrons.

Photons are emitted upon the occurrence of the annihilations (which can used to generate other usable energy as described elsewhere in this specification), but the net result in terms of the leptons is that the target material has one fewer electron than before the event. As this is repeated, the target spinel (or other material) core progressively gains a positive charge, becoming progressively electron depleted.

Once a sufficiently strong positive charge is achieved, the spinel core is a finished product. No more positrons are required. The positive charge is static and produces a strong positive electric field that reaches through the insulated lining and is capable of doing work. There is no equivalent of field emission (loss of electrons from a negatively charged material). Therefore, it is possible to sustain the positive charge on a theoretically perpetual basis, relying on the insulated coating (optionally including a vacuum or insulating gas layer—pressured or at atmospheric pressure) to prevent electrons from the surroundings from crossing into the electron depleted core. Some limitation on the voltage is presented by breakdown of the target material, but there are a wide variety of target materials—such as mechanically ground particles of some metals such as silver—where in breakdown does not necessarily result in destruction of the core—particular depending upon the efficacy of the insulating coating.

This type of charge accumulating positron system device involves a positive electric field but no electrical stream or current to cycle out or recycle any electrons. In this aspect it differs from and provides different operational design challenges relative to such core and cylinder type annihilator electrical stream component described above. To function usefully, the force lines of the static positively charged device may need to extend outwards into the surrounding space or inward into a cavity within. Critically, a separate device component must be used to provide the positrons to accomplish the electron depletion, but the source device can then be removed as charging is completed. If the charging device develops a negative charge it will attract the force lines and will begin to require extremely high mechanical power to remove the source from the interior or from the area of the charged target material due to very powerful electrostatic attraction.

The negative charge develops in the positron emitting source material because with each emission, a proton becomes a neutron so that the atom requires one fewer orbital electrons. Where the physical design is such that the positron departs the emitter source material to enter the target, the source is left with a mounting number of excess electrons and hence a progressively more negative charge.

However, the inventor has appreciated that, as positive charge develops in the surrounding target, charge conservation can be adapted in the source by the use of chemical assembly and time factors to control charge balance. The particles in the charging source—optionally fluidic—are (e.g.) made in one set with a positron emitting nuclide such as ⁵²Mn and in a second and separate set with a β⁻ emitter such as ⁹⁹Mo or ⁵⁹Fe. The molybdenum isotope undergoes beta minus decay with a three day half life, for ⁵⁹Fe it is 45 days. After formation, each β⁻ decay changes a neutron to a proton with expulsion of the emitted electron. This results in a positive charge for the atomic nucleus until it can capture a free electron into its outer shell. Once it does this, the atom becomes neutral, as does the bulk material. If the volume of the reaction material is large (greater than 1 cm), the emitted electron remains in the material and become available to serve as the additional orbital electron. However, if the decay takes place in a narrow fluid cylinder (e.g. wire-like) and if we provide a routine electric circuit to present an anode, then the expelled electrons can disappear from the solution. With each β⁻ disintegration, the bulk fluid becomes short by one electron and so develops a bulk positive charge.

After several half lives, the solution with the technetium-99 emission daughter product (or cobalt-59 respectively) is a prepared positively charged solution that can be mixed with a solution carrying fresh ⁵²Mn particles. The ⁵²Mn decays by positron emission with it's 5 day half-life. These atoms change a proton to a neutron, with emission of the positron. As each ⁵²Mn disintegration event occurs, we have an excess outer shell electron remaining, but these electrons are scavenged by the technetium-99 that results from the ⁹⁹Mo decay. By carefully setting the stoichiometry and mixed amounts, eventually, the material turns neutral slowly as the ⁵²Mn is substantially consumed. Events inside the fluid are dominated by local charge effects, interactions between the fluid and target material are dominated by the forces of nuclear disintegration which cause energetic displacement of the charged particle at MeV scale energies that overwhelm local charge effects until the kinetic energy is dissipated.

To avoid providing emitting electrons to the material to be subject to electron depletion, the fluid is first turned positive by electron emission while exterior to and distant from the target. Currents are used to do the work of removing the emitted electrons. Sufficient half lives may be allowed to elapse with a short half-life β⁻ emitter as to effectively complete the period of electron emission. Later the positron emitting material is mixed into the previously formed positive material. Although, once formed, a nuclide undergoes continuous disintegration at a rate expressed by its half life, the practitioner of this invention produces particles to reach a certain specific activity—by e.g. providing a certain amount of exposure of a target in a cyclotron, measuring radioactive output from the completed target and then synthesizing particle that are then ultrafiltered for relative concentration and dilution to produce the desired starting point radioactivity.

Due to these considerations it is possible to accomplish a time sequence wherein the β⁻ component has substantially completed electron emissions for the purposes of the particular charge design contemplated. For example, if a positively charged material is to be formed by depleting it of 10⁸ electrons, then a first β⁻ source fluid with 10⁸ emitters is prepared. After ten half lives relatively few beta particles remain to be emitted. At that point, a positron fluid with 10⁸ positron emitters is mixed into the electron depleted β⁻ fluid. This mixture is then introduced into the vicinity of the target. At the end of the manufacturing process, the target is depleted of 10⁸ electrons due to annihilations and is positively charged, but the source fluid is now neutral and is readily removed from the interior of the positive target with a reasonable amount of mechanical force.

The reasons for preferring a positron generated positive target material over a β⁻ emission generated positive material, includes the fact that no electrons need to be removed by a circuit as the positron generated target material with electron depletion is formed. This allows for a larger bulk material (greater than a few millimeters in cross section) to be made positive. In addition, the resulting positively charged core can be composed of any material at all and never has any radioactivity required in it. However if the β⁻ emission material is to be used to produce a positively charged material, it must actually comprise a radioactive Beta emitter which complicates and limits its use.

In a design of a preferred embodiment (see FIG. 4), a charging rod 31 is introduced as a complex central rod. The outer aspect of the rod provides for a thin sheet of positron loaded fluid 33 to pass through it and the center of the rod is low density material or vacuum 30 so that positrons may pass through it 32 to enter the annihilation zone after cross the opposite side of the charging cylinder then passing through the inner low density insulation coating of the outer cylinder. The positrons load the charge into an outer ring material 34—a cylinder or series of rings—turning it positive by depleting it of electrons. The positive charge lines 36 reach through the outer insulative coating 35. The inner rod becomes neutral as this goes on due to the charge balance mixture of positron emitters and beta minus electron emitters. The rod is then withdrawn. The result is an empty ring that has the desired positive charge that can be used for “no power input” ionization work.

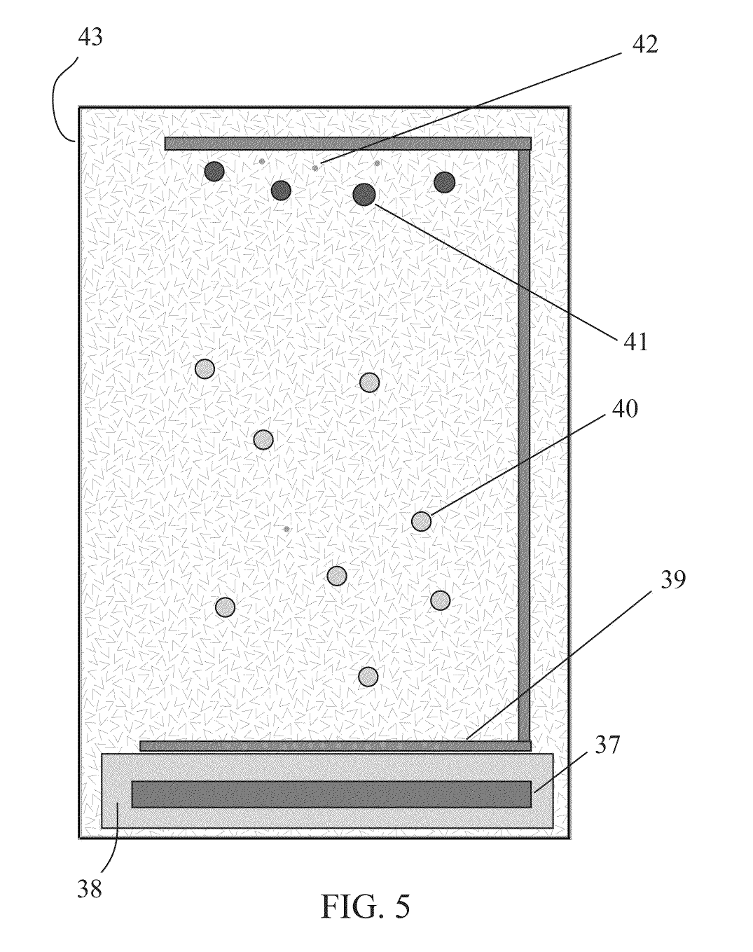

There are a wide variety of uses for a positive field source. These include the capability to re-charge batteries placed nearby as well as, for instance, the production and maintenance of an ionized gas for a fluorescent type of light that will provide illumination continuously with the drive provided by the constant positive field and no other energy input required (see FIG. 5). In FIG. 5 the diagram shows the positively charged disk 37 emitting its positive electric field through an insulator 38 which cannot counter or redirect the field becomes of its relative absence of free electrons. The field pulls electrons out noble gas molecules such as argon rendering the gas atoms as ions 41 which migrate away from the positive field source. The electrons accumulate on an electron collection grid 39 that is part of a conductor connected to an electrode at the top of the device electrons are drawn to the top electrode as gas ions reach it, but after emission 42 they can be accelerated toward the positive charge. They impact the mercury vapor atoms 40 as they travel and this causes those atoms to emit photons which impact the outer glass 43 of the device so that it's fluorescent coating glows and light is emitted.

See water desalination by ionization is another important application for a positive charge electric field device such as this. Except for use of the stable continuous positive charge source many other aspects of the device—such as a fluorescent light—are well known to those skilled in the art of manufacture of the relevant device.

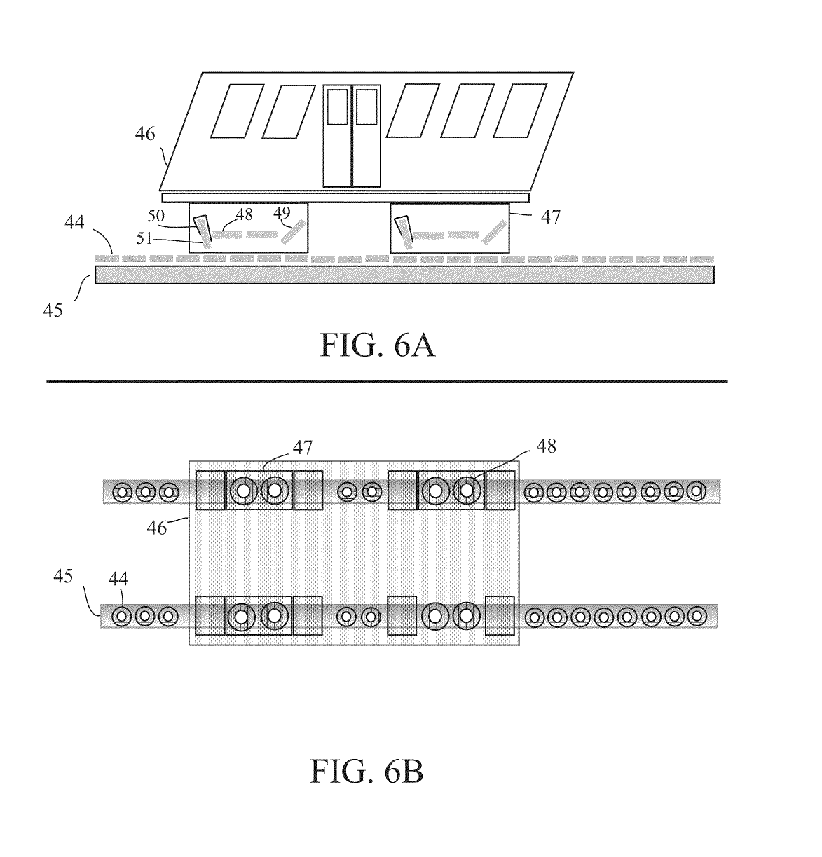

Yet another use is for a levitation system in which the positively charged elements are arrayed in a floor or road structure and also in the undercarriage of a vehicle. Where such a system is capable of construction as a rail-type conveyance (see FIG. 6), it will be possible to readily provide a sealed forward sliding vacuum system and electron scavenging system between the vehicle and the rail. By minimizing and removing excess electrons, the charge effect of the stable fixed positive field elements above and the stable fixed positive field elements below will be to provide a levitation effect. In FIG. 6 an array of electron depleted disks providing a positive electric field 44 are fixed along a rail 45. The vehicle 46 is supported on levitation and drive units 47 that incorporate another set of electron depleted disks providing a positive electric field 48 whereby the opposition of the positive field in the rail results in a levitation effect. The posteriorly directed positive field disks 49 help provide propulsion as they are repelled and an additional disk at high charge accumulate stray electrons that enter the vacuum chamber 47 of the drive unit. An electron collection grid conducts the electrons to a lower potential energy position on the anterior surface 51 of the leading disk 50 where it can be rotated into position to contribute to a braking effect.

The scavenging subsystem can use additional positively charged elements positioned in front of and following the levitation components in which the positive charge—at a higher charge than the levitation components—is used to attract and retain stray electrons wherefrom they may be harvested and withdrawn or rather used in place as during the application of braking function for the vehicle where the accumulated negative charge is turned into a position of exposure to the positive road or track below. The electrons may be caused to accumulate on a surface of the braking portion by using a collecting wire grid that leads to a wire capable of conducting the electrons to the surface of the braking component that is away from the levitation space. Here the conduction array is positioned closer to the positive core although still separated from it by insulating material. The closer positioning results in lower potential energy and so causes the collected electrons to flow towards and accumulate at that region. When the braking component is rotated toward the rail, the electron region will be attracted to both the rail and the to collection system and a braking effect will result. The positive charge elements affixed to the rail or road also have electron collection grids that are connected to a more proximate location on the lower surface of the charge element and also to ground.

An entirely different use of the positively charged disks is the design of a plasma based rocket engine. In such a device a noble gas is introduced into a chamber where an electric field ionized the gas. Here the chamber entry and body would be lined with positively charged electron depleted insulation coated material with high heat resistance such as a thin layer of ceramic. The positive electric field would be used to ionize the gas as well as to propel the positive ions out of the rocket nozzle as they are repulsed from the positive material in the rocket chamber wall.

### D. Use of a Lepton Emission System to Drive a Cyclotron

The major power consumption demand in a superconducting cyclotron is in establishing and rapidly reversing the high electric field in each Dee. However, if an annihilator component is used to establish a very high field, then a very high voltage switch could allow application of the field to the Dees, so that no additional energy input is required. This would generally allow for much higher voltage for the Dees then is generally available. Thus milliamp beam currents could be achieved, greatly improving yield, without the expensive and complex electronics currently required.

These fields can be used to provide the electric field to the cyclotron D's thus reducing power requirements once the process is kindled. What is needed to drive the cyclotron is an oscillating square wave rather than a typical sinusoidal radiofrequency signal. This can be accomplished through a piezoelectric or inductor/capacitor oscillator (LC tank circuit) or relaxation oscillator with a Schmitt trigger. Alternately an array of synchronized flip/flop latch circuits could be coordinated electronically to apply or disconnect numerous small field sources to a copper Dee. In this fashion the field would be applied and disconnected without a large amount of current flow through any one switch. This is feasible if the field is formed in an annihilator component—so these may be deployed as numerous compact high field devices kept in a shielded zone that is intermittently connected to the Dee to accomplish the square wave oscillation of the applied field.

There is a concept of four energy release steps: 1) a nuclear disintegration, 2) an electrostatic transformation and 3) a matter to energy annihilation and optionally 4) an interaction of the annihilation photons with matter to displace electrons.

Another feature of the energy balance relates to the energetic cost of producing a very high voltage electric field by annihilation of electrons. When annihilation takes place at rest energy within the material that is emitting the positrons, there is charge neutrality. The nucleus becomes more negative as the positron leaves, but when the positron annihilates an electron, the charge balance is maintained in the bulk material. As noted above, when this occurs at rest, all of the mass converts to energy and there is no other energy to account for.

However, when the positron travels into another material and annihilates an electron there, a positive charge develops because of the progressing electron deficit in the receiving material of the annihilation zone. In small amounts, the energy of creating the static electric field from one lost electron seems very small, but it is important to consider what happens with the elapse of time as the receiving material becomes massively charged—e.g. gigavolt charge due to loss of electrons. The positron may still enter the positively charged material because of the drive from kinetic energy of nuclear disintegration being capable of overcoming the electrostatic repulsion, however, it becomes clear that there is an energy transfer from the disintegration to the progressive increase of the charge of the electric field.

Little is known about the ability of electrostatic attraction of a very strong positive field surrounding a positron, to impede the fusion of the positron with an electron. If more energy is required to accomplish the fusion in this setting, there will be less energy available to form the annihilation photons.

### 11. High Energy Interactions for Pair Production to Produce Positrons

### A. Annihilation Chain Reaction

At one level, it is well understood that a positron will lose energy by interactions with various atomic components in the medium through which it travels until it can interact with an electron “at rest.” At this point, an annihilation will result in two photons, traveling in opposite directions each at an energy equal to one half the rest mass of an electron—511 keV. However, if there is significant kinetic energy in the positron or electron at the time of the annihilation, then the energy in the annihilation photons will be higher. They will carry the energy of the rest mass, but also any imparted kinetic energy.

Under many situations contemplated in standard physics, the “electron at rest” concept is universally applicable. However in a positronic fluid—such as the material disclosed in this specification, this assumption can be incorrect.

When a high energy photon drives a K or L shell electron out of the atom due to a high energy photoelectric effect, the result is a high energy electron with energies commonly reaching over 400 keV. When a large number of annihilations are caused to occur close together in an environment where photoelectric effects are expected, there will be a region in which there are both high energy electrons and high energy positrons in some abundance.

Another source of high energy electrons possible in the ferrite nanoparticles arises from the potential to include nuclides that undergo transmutation by emission of an electron. For instance ⁵⁹Fe decays with a 44.5 day half life and yields a 237 keV electron at 48% along with its 57% emission of a 1.099 MeV gamma ray. ⁵⁹Fe can certainly be easily incorporated into the ferrite particles along with the ⁵²Mn positron emitter. The emitted electrons and positrons will experience opposing curvature of their path of travel when the magnetic dipole of the superparamagnetic particle is settled.

As shown in Filler's U.S. Pat. Nos. 5,948,384 and 6,562,318, the use of high density media as carriers for positron emitters results in a more than six fold increase in the linear proximity of annihilations to disintegrations. Overall this means that both positrons and high energy electrons resulting from photoelectric effects (or B emissions) will be packed an order of magnitude closer to each other than has been assumed in standard models when considered in terms of the linear restriction in channels. Considered as a volume, however, the decrease of radius to one sixth is accompanied by a decrease in volume of the sphere in which the annihilations take place by a fact of V=4/3 π ³ so that a volume for 6 millimeters of travel is 904 mm³ but the volume with just 1 mm of travel is just 4 mm³. The volume is decreased (and the energy density is increased) by a factor of 216.

If a positron with a 400 keV kinetic energy fuses with an electron having 400 keV kinetic energy then the energy to be distributed between the two annihilation photons will be 1.822 MeV rather than the rest mass energy of just 1.022 MeV. The result will be annihilation photons with energies of about 911 keV rather than 511 keV. These photons with increased energy can similarly eject progressively more energetic photoelectrons with resulting annihilation photons that can cross the threshold of 1.022 MeV. When a photon with 1.022 MeV of kinetic energy impacts a relatively massive nucleus it can abruptly lose its momentum and produce a positron electron pair through the well understood process of pair formation.

In fact, pair formation is significantly more likely to occur with passage through a material composed of atoms of higher Z-number compared to a material of lower Z-number because of the difference in the role of the predominant photon attenuation effects. The photoelectric effect—which yields a scattered photon and an electron—varies as Z⁴/E³ (E=photon energy) so is most important at lower photon energies. The Compton effect which similarly yields a scattered photon and an electron occurs nearly independently of Z-number but becomes less important at higher energies since it occurs at a rate that is proportional to the number of electrons per gram—which is fairly uniform across the periodic chart. Higher energy photons above 1.022 MeV can engage in pair production, but the likelihood increases in proportion to Z². It is unlikely to happen near 1.022 MeV in a low Z material like carbon (Z=12, Z²=144) but would only be seen at energies above 5 MeV. However in a high Z material like lead (Z=82, Z²=7,921) the likelihood is significant for any photon above 1.022 MeV. The photon needs to impact directly with a massive nucleus that dissipates the momentum of the much less massive photon without significant recoil, so that energy is absorbed in an energy to mass conversion that leads to production of an entirely new electron and positron rather than a scattering or displacement of an existing electron as in the photoelectric effect or the Compton effect. As more photons engage in pair production, fewer are available for Compton interactions as a fraction of the number of photons in an incident source of photon irradiation.

Therefore, this invention discloses, that just as nuclear fissile material can reach a critical mass at which a nuclear chain reaction can be sustained, it is possible to use the methods of this invention to produce a sustainable and controllable self sustaining positronic matter-antimatter chain reaction.

A kindling material containing positron and electron emitting nuclides initiates the production of annihilation photons. However, where the positrons and electrons are accelerated in a static voltage field they undergo collisions to trigger the annihilation rather than and as opposed to the electrostatically driven type of annihilations due to loss of energy through particle interactions where they approach a rest state with no kinetic energy in the reference frame.

The additional kinetic energy imparted to the high energy electrons and positrons by the static field is then harvested as higher energy annihilation photons. These higher energy annihilation photons strike nuclei and result in pair production providing new high energy electrons and positrons. This can become a continuing process depending upon the applied static voltage and not upon the presence of any radioactive emissions.

### B. Device Structure for Positron Chain Reaction and Energy Extraction

Using the augmented lepton battery type of arrangement, very high voltages can be achieved. As noted above, when electrons and positrons are accelerated to above 1.022 MeV each, then there is sufficient energy in the resulting annihilation photons so that each photon can produce one more electron and one more positron. This results in a chain reaction because we start with one electron and one positron, accelerate them before collision, and then have two high energy (>than 1.022 MeV photons). Each of these photons can impact a nucleus upon which we harvest two electrons and two positrons from the two pair production events caused by each of the two very high energy photons.

By first using the electromotive force of nuclear disintegration to cause a high voltage electron depleted positive electric field, this standing field can be used to accelerate the leptons without additional energy input to sustain the electric field.

When the electrons and positrons from pair production are accelerated, another doubling can occur. However, this process can further be amplified to account for losses and inefficiencies in the chain reaction. Using the augmented battery effect the acceleration of the electron and positron can apply a million electron volts of additional acceleration to each so that there are 3.066 MeV to be dispensed in the annihilation. In this fashion, at higher voltages for acceleration, additional numbers of higher energy photons can be created to increase the growth rate of chain reaction.

To understand the scale of forces that can occur, we can examine the effect of one mole of a positron emitting material a distance of 1 centimeter from an β⁻ emitting material, after ten half lives, assuming no breakdown and no emission or absorption of electrons. F=k q1×q2/r2, where k is the electrostatic constant (8.987×10⁹ N m²/C²). The charge of each electron being 1.60×10⁻¹⁹ coulombs, and the charge in one coulomb being the charge from 6.24×10¹⁸ electrons. With Avogadro's number (6.022×10²³) of excess and deficit of electrons respectively, the charge (q) is 9.63×10⁴ Coulombs.

To fill in the force formula, F=(8.987×10⁹ N m²/C²)(9.63×10⁴ C×9.63×10⁴ C)/(0.01 m)². F=k×(92.83×10⁸)/10⁻⁴. F=8.9×10⁹×9.2×10¹⁸. F=8.188×10²² Newtons. If the two elements are 1 meter apart, the force is still 9×10¹⁷ Newtons.

For a single component relative to a test charge at one meter, the equation is F (Newtons)=(8.9×10⁹N m²/C²)(9.63×10⁴ C)/1 m²=8.5×10¹⁴ N/C a field measurable as 850 Teravolts. If we start with 0.5 millimoles—the amount of ⁸⁹Zr that could be produced in one day by a 1 milliamp beam intensity cyclotron—then the charge would still reach 400 Gigavolts arising in a mass of material of 40 milligrams. A day's production from a small cyclotron with a 30 microAmp beam intensity would be 40 gigavolts.

The constant “k” is the coulomb constant which represents the fact that two point charges of 1 coulomb each (each composed of 6.241×10¹⁸ electrons) placed one meter apart would experience a repulsive force of 9×10⁹ Newtons—a force equal to the gravity effect of about a million metric tons on the earth surface. Using the annihilator component, one coulomb would result from 6.241×10¹⁸ positron disintegrations-annihilations—the number of atoms in about 10 micromoles of a positron emitting material. These calculations the very significant static field effects that can be created with relatively small amounts of purified conductive solid positron emitting material such as has been described in this application.

Unlike positron emission or β⁻ emission, when leptons are released by pair production and then subsequent annihilation of these pair production leptons occurs, there in no net gain or loss of charge. Therefore, only emission leptons can be used for the lepton battery effect. The high voltages produced by annihilation of positrons or to some extent by accumulation of β⁻ emission electrons, can be used to accelerate electrons and positrons to achieve pair production. The usable energy from the pair production chain reaction is in the form of the high energy photons that must then be used to generate electricity by e.g. photoelectric and Compton effects.

Another method to increase the production of higher energy photons is to amplify the arrangement where an electron beam is directed towards a positron emitting surface or into a positron cloud. However, the electron beam is passed through a series of stages, each providing additional acceleration, but requiring no very high additional voltages—adding for instance a 511 keV acceleration at each stage as the electron passes a series of 511 keV electric fields.

Further, when a strip of high voltage positron emission source material is aligned with a strip of high voltage β⁻ electron emission material, a high potential electric field will develop between the two so that electrons will be field emitted and directly emitted from the β⁻ side and positrons will be directly emitted from the positron side. The kinetic energy acceleration is due to the potential difference and is not affected by the distance of separation of the two strips. High kinetic energy collisions and resulting annihilations will occur in the space between the strips that will generate very high energy photons capable of causing pair production. The high voltages in the strips can be maintained by flowing fluids through the strips that carry positron emitters (on the positron side) and that carry β⁻ electron emitters on the electron side.

### C. Modulation of the Chain Reaction

Modulation of this reaction can be accomplished by four means. Firstly, when the positronic ferrofluid is formed, the positronic superparamagnetic particles will be separated from each other by—for example the water in which they are solvated. The inventor has previously shown (Filler U.S. Pat. No. 5,614,652) that using centrifugal ultracentrifugation, the concentration of the particles can be increased at will. The objective here would be to bring the concentration of the particles high enough that it is nearly at a critical level. Then, when an external magnetic field is applied to settle the very rapidly flipping magnetic vectors, the fluid is magnetized and the particles move closer together to a degree dependent on the strength of the applied external magnetic field. In this way approach and departure from criticality can be precisely controlled from an external electric circuit.

A second means of modulation is the effect of the external field that tends to draw electrons and positrons towards the respective outer surfaces of the particles and then to subject them to acceleration in the external field. This counters the de-energization that occurs by interactions with the iron atoms in the particles. Thus the particles tend to reduce the energy and inhibit any chain reaction when no external field is applied promoting lower energy electrostatic annihilations, but the external field can add kinetic energy so that high energy collision annihilations are promoted instead.

A third component of modulation concerns the magnetic field generated by each positron and electron as it travels. When the direction of travel of electrons and positrons is essentially random, there is no structured effect of the leptons' own magnetic fields (lepton refers to the electrons and positrons). However, when the region of superparamagnetic particles in which the leptons are traveling becomes directionally magnetized, the electrons and positrons are driven in different directions from each other by the Lorentz forces from the surrounding magnetic field, but in both cases (electron case and positron case) tending to drive the leptons out of the magnetic environment that exists inside the nanoparticle.

A fourth component of modulation to promote collision of energetic positrons and electrons is magnetic concentration. Although magnetic lenses are a routine aspect of linear accelerators and circular accelerators such as synchrotrons, there has not been any consideration given to use of such magnetic effect on very small scale or in two dimensional or three dimensional arrays. This is done in the current invention to accomplish and produce an efficient reaction chamber for positron chain reactions rather than being done to guide or focus a beam. It is proposed here to manufacture and apply a magnetic sieve that acts to concentrate high energy electrons and positrons to promote desirable collision annihilations (see Section E below).

Overall the consideration of the effects of the magnetic field on the positron emitting medium are complex and are considered as follows:

One can imagine a volume with an array of positron emitting atoms, situated in a magnetic field. For conceptual effectiveness, however, it is helpful to consider a large number of atoms as if they were placed exactly at the same location. In this situation, an observer would see a series of emissions from the center traveling outward in all directions.

The effect of the magnetic field will be different for positrons traveling perpendicular to the magnetic field and those traveling parallel to it.

Because the positrons are moving—carrying initially several million electron volts of disintegration energy—they generate their own magnetic fields that interact with surrounding main field.

Those traveling perpendicular to the field will experience a torque that tends to make them turn towards the left. This is true no matter what direction they are traveling within the perpendicular plane.

In isolation, those in this perpendicular plane will appear to first shoot outward in all directions, but then to form a series of spiral arms. However if we consider just those particles moving parallel to the magnetic field, there is no effect on direction.

For those moving between parallel and perpendicular, we have two components to apply—result is more curve for those closer to the perpendicular plane. However—if there is an electric field and a magnetic field, the two forces are independent and additive.

When the electric field is aligned with the magnetic field, particles moving in the direction of the field are unaffected by the magnetic field, but differentially affected by the electric field. Those moving parallel to the electric field are accelerated in that direction, but those moving anti-parallel, start to lose velocity and then reverse to head parallel. Those moving perpendicular and spiraling, gain a direction parallel to the electric field as they spiral. They all eventually move toward the electric field parallel, but form a wide disk of impact with those affected by the magnetic field having the widest distance from center.

When the electric field is aligned perpendicular to the magnetic field, we consider six different conditions.

For a particle moving parallel to the magnetic field but perpendicular to the electric field in either direction, the particle curves towards the direction of the electric field. As it turns to move toward the electric field direction, its motion engages with the magnetic field and progressively acquires an angular momentum toward the left.

For a particle moving perpendicular to the magnetic field but parallel to the electric field, it's curve to the left is modified to a more shallow curve as it gains momentum towards the electric field direction.

For a particle moving perpendicular to the magnetic field and perpendicular to the electric field, towards the left, the particle experiences a leftward angular momentum from the magnetic field and a rightward momentum towards the electric field and tends to travel perpendicular to the electric field, towards the left, if the field strengths are equal.

For a particle moving perpendicular to the magnetic field and perpendicular to the electric field, towards the right, the particle experiences a leftward angular momentum from the magnetic field and a similar additional leftward force from the electric field and tends to turn towards the electric field.

For a particle moving perpendicular to the magnetic field but anti-parallel to the electric field, it's curve to the left is modified to a steeper curve as it curves and then turns towards the electric field direction.

For a similar experiment with an electric field only, all particles curve toward the electric field parallel direction if the field is greater in strength than the momentum imparted by the emission event, or as the particle loses kinetic energy through its interactions.

Overall, the effect of the perpendicular magnetic field in the presence of an electric field is to cause a general leftward “spray” of the impacts at the field source line. When perpendicular, it causes a decrease in size of the impact disc because those particles traveling perpendicular must travel through a spiral rather than travelling directly perpendicular to the field.

When the source is not a point, but distributed, there is little impact of the magnetic field.

When the magnetic and electric fields are organized in the form of a cyclotron, the positrons will be accelerated. If two cyclotrons are used—one for electron emission and one for positron emission, the beams can be arranged in the form a of a collider, or can be arranged to be nearly parallel. In this configuration, there will be very little relative momentum between the beams even though the kinetic energy of both beams will be present. As the two beams slowly merge, electrostatic forces will cause annihilation of the high energy leptons resulting in high energy annihilation photons. Conservation of momentum suggests that the annihilation photons will travel parallel to the beams rather than at 180 degrees to each other. The 180 degree motion is only required to conserve the zero momentum when electron and positron are at rest at the time of annihilation.

If the beams are arranged perpendicular the efficiency will be reduced, but the direction of the photons will add the momentum of the two beams and both will proceed at 45 degrees to the two beam directions, moving in the quadrant away from the cyclotrons.

### D. System for Concentration of Pair Production

Where a magnetized ferrofluid travels in a thin tube or cylinder, the magnetic field along the axis of the tube, causes an electric field resulting in a curved path of free electrons and positrons according to Lorentz force theory. For this reason, when a positron emitting ferrofluid is magnetized and in movement, there is an electric field generated that helps add kinetic energy to emitted positrons. However, electrostatic forces from electrodes charged to very high voltage can provide far stronger forces.

Very high voltage can be created by a Van de Graaff system that causes charge to accumulate on the outside of a partial sphere acting as a Faraday cage around an electron delivery source. In a Faraday cage—as a focus of charge accumulates or is applied to a location on e.g. the outer surface of the cage, electrons flow toward or away from the focus along the inner surface in way that prevents the field lines from traveling through the interior of the cage.

Alternately series of capacitors can be used to accumulate large static electric potentials. These voltages, when applied properly, can impart significant kinetic energy to electrons and positrons. Voltages of thousands or even millions of volts can be achieved, although high electrostatic voltage potential can ionize some materials and gases and this requires specialized materials designs based on the actual voltages required.

Aside from the issue of the strength of the electrostatic field is the issue of how to best apply the field to achieve the desired electricity producing effects in a positron based system. One method is to use a large shaped flat electrode to apply the electromotive force uniformly along an extended region.

In one example, a simple tubular system is assembled with side A of the tube (for demonstration—the left side), having a linear charged plate that has a positive charge. As positrons are emitted, the charged plate directs them to move towards side B. The charged plate can be formed as a U-shaped, semi-circular trough with its opening directed towards the tube. When two separate U-shaped troughs are used, the electromotive force is concentrated at the edges of the U while the interior space may have no charge due to Faraday cage effects.

The result is that the magnetic field can add kinetic energy and direction—limiting movement in the axial plane of the tube. The electric field drives the positrons towards side B (for demonstration the right side). If we have a β⁻ emitter in an adjacent tube undergoing similar but opposite effects, then it will drive its electrons towards the A tube. Construction is simpler if the energies of the positive and negative betas are similar.

The design here is intended to promote annihilation between energetic beta particles of opposite charge, ignoring the plentiful rest electrons that are stably remaining in the source tubes. Once the positrons emerge from a ribbon of fluid in a flat sheet container, into a vacuum in the presence of an attractive electric field they will travel towards that field. The voltage can be set by the electrodes. For a ribbon, the electrodes may be flat rather than U-shaped. Ejected β⁻ particles will experience the opposite force driving them towards the center.

An alternate design uses a hollow cylinder for the positron emitter fluid with an outer layer having a cylinder electrode that is positively charged. In the center is a filament that is negatively charged and around the filament is an optionally flowing layer of β⁻ emitting ferrofluid in a small hollow cylinder. The high energy electrons will flow outward from the inner cylinder, while positrons flow inward towards the center. The design causes annihilations to take place in the space between the outer and inner cylinders. In a coaxial cylinder such as this, the outer conductor causes a Faraday cage effect, so that the electromotive field inside the cable is due to the central conductor wire only.

Annihilations between energetic β⁻ β⁺ pairs results mostly in photons, although other pairs can result. Annihilation photons will mostly pass through the beta source regions to reach a thick outer layer—a third cylinder outside the positive cylindrical electrode and will there undergo photoelectric effects and Compton effects to generate electrons that flow along the length of the photo-electric layer due to a voltage applied to either end of the photo-electric layer. Any gammas emitted by the disintegrations of the beta fluids will also enter the photoelectric layer.

If the entire three layer cylinder “rope” is wrapped around and along a linear cylinder core in a spiral, then the all gammas will emerge to the outer layers. A fourth outer photoelectric layer can be formed as well. The effect is that any photons that are in effect traveling along the long axis of the annihilation zone will pass out of the central area of the rope as they go straight and the cylinder curves. The photoelectric layers can be liquid or standard copper conductor or preferably silver, gold or iridium foil or tubing which are progressively higher Z-number materials with high electrical conductivity. The higher Z-number material will be most effective at causing absorption of the gamma rays and high energy annihilation photons, particularly for pair production. A high density of nuclei also increases the relative probability of pair production. Here, where both lead (Z=82) and iridium (Z=77) are high Z-number materials, the density of lead is 11,340 kg/m³ while the density of iridium is 22,650 kg/m³ (the highest in the periodic chart—more dense than osmium based on the lattice structure), so that high energy photon interaction with iridium is expected to more efficiently lead to pair production. Mercury (Z=80) has a density of 12,534 kg/m³. The conductivities of osmium is 12×10⁶ S/m, of iridium is 21.0×10⁶ S/m and of lead is 4.55×10⁶ S/m, so that iridium, with its high Z-number, high density, and high conductivity is excellently suited to retrieving electrons from photoelectric interactions. Gold similarly is useful because it's Z=79, conductivity is 45×10⁶ S/m and density is 19,300 kg/m³.

The Compton effect, photoelectric effect and other similar phenomenon pertain to situations where energy from an incoming photon displaces an electron from its usual orbital where its movements are dominated by the positive electric field and mass of the atomic nucleus, allowing the electron to enter the conduction band. However, another electron from the conduction band can then move into the vacant orbital. In order for a usable current to arise, there has to be voltage and a circuit so that the displaced electrons will tend to flow into the circuit in order to return to the source site. In a photovoltaic cell, this is accomplished with the pn junction causing an electric field and a barrier to conduction so that there is directional flow of displaced electrons out the cell. In a pair production event, new electrons are created and enter the conduction band, but new positrons are created at the same time that can destroy electrons. To get a usable current from the Photoelectric/Compton/Pair Production (PCPP) material, there must be a an electric field across it that causes the displaced electrons to flow towards the positive potential voltage source, while the same field causes the positrons to flow in the opposite direction. A circuit connection will allow the displaced electrons to flow through the circuit and do work in the course of returning to the opposite side of the PCPP material to replace electrons lost because of their displacement in photoelectric and Compton interactions or to replace electrons annihilated by the positrons. Thus there must be a polarity across the PCPP material. The situation is similar to the semi-conductor photovoltaic disposition, but involves “holes” caused by electron displacement and also “holes” caused by positron annihilations.

By selecting a very high energy β⁻ emission, the β⁻ particles approaching the β⁺ layer will tend to impart a high energy to the annihilation photons. When the annihilation photons are greater than 1.022 MeV in energy, they become capable of causing pair production that generates new positron-electron pairs. If pair production occurs in the positronic fluid, then the structure will direct the positrons back into the annihilation region of the rope. Similarly, any high energy gamma rays from the β⁻ layer will reach the encircling β⁺ layer and if pair production positrons result, these will also be drawn into the annihilation region.

Any pair production in the photoelectric layer should encounter/result in positrons that flow outward in the rope. These can be accommodated by an additional layer set. The most external layer is a negatively charged electrode layer and just inside this is an outer cylinder with a flow of β⁻ emitting fluid. These are driven into the outer annihilation region to generate photons from chain reaction annihilations in the outer region.

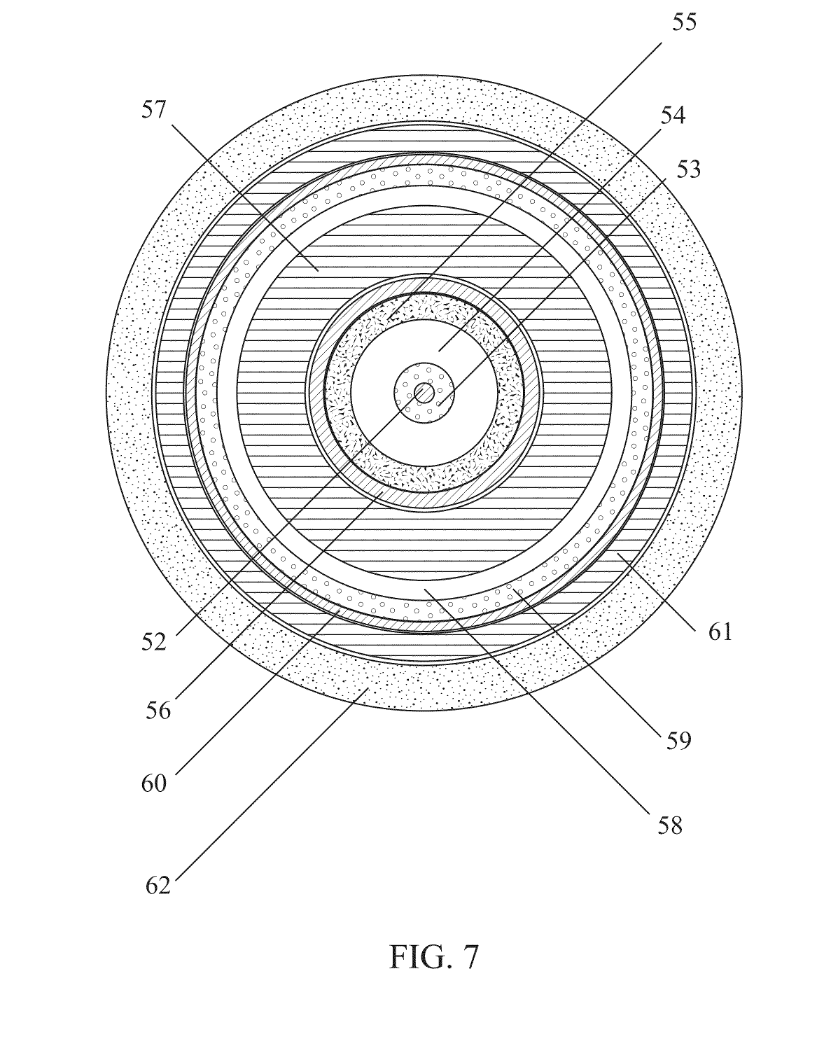

An embodiment of the structure is shown in FIG. 7. It comprises a central very high voltage negatively charged electrode 52, surrounded by an inner β⁻ emitting fluid layer 53. The emitted electrons are driven away from the negatively charged central electrode and so travel outwards into the primary annihilation zone 54. The positron emitting fluid is contained in a ring layer 55 just outside the chamber and it is provided with a positively charged very high voltage cylindrical electrode 56, that acts together with the central negative electrode 52 to drive positrons inward and pull electrons outward so that they tend to collide in the annihilation zone 54. A thick layer of conducting fluid and high Z-number material surrounds the annihilation system in order to provide a location for photoelectric, photovoltaic and Compton effects that tend to push free electrons into the conduction band of the conducting material in 57 wherein that conduction layer is provided with a positive voltage at one end and negative voltage at the other end to promote the coherent movement of freed electrons into an electric current. Because pair production will also take place in 57 when kinetically energetic positrons and electrons cause high energy photons to impact atoms in 57, a secondary annihilation zone 58 is provided outside the 57 ring and an outer source of electrons is therefore provided in a second outer β⁻ layer 59 surrounded by an outer very high voltage negative electrode layer 60. There is then provided an outer photoelectric, photovoltaic and Compton effect layer 61 to scavenge electricity from photons that continue to move outward in the rope. Finally there is an outer shield high Z-number layer 62 whose purpose is to minimize the emission of any undesirable high energy gamma rays that may continue to move outward.

There is no requirement for the central electrode to be a wire as opposed to a cylinder as well. A simple way to manufacture a multi-layer cable of this sort is to assemble the layers as a stack of flat layers and then bend them around a central core, using the outer shield to secure the structure into a cable.

Where higher power applications may lead to significant heating, the positron carrier, the β⁻ layer and the photoelectron layer can all be constituted with variations of the gallium, indium, tin alloy—such as GalInStan which will expand linearly with heat inside a rigid cylindrical container. The electrode layers can be constituted with alloys such as Invar (FeNi36) that have very low coefficients of thermal expansion and which can be coated with copper or made with copper incorporated in the alloy to optimize the electrical conductivity. The positron and electron layers can incorporate zirconium tungstate (Zr(WO₄)₂) which also does not expand with heating and which is useful where it incorporates ⁸⁹Zirconium as a positron emitter for the β⁺ source function and ¹⁸⁵Tungsten as a β⁻ emitter. These can be manufactured as nanoparticles can be incorporated in polymers such as epoxy and other resins, polyimides, phenolic resins and various polyesters (see Wu, H. et al: Zirconium Tungstate/Epoxy Nanocomposites: Effect of Nanoparticle Morphology and Negative Thermal Expansivity, ACS Applied Materials Interfaces 5:9478-9487, (2013)−attached). Many of these can be mixed, poured, cast and polymerized with heating or by catalyst methods.

Flexibility and tolerance of heating is also an aspect of the use β⁻ emitting noble gases such as ⁸⁵Krypton (T_{1/2}=10.7 years); ¹³³Xenon (T_{1/2}=5.2 days) and β⁺ emitting ¹²⁵Xenon (T_{1/2}=16.9 hours), and ²¹¹Radon (T_{1/2}=14.6 hours).

### E. Magnetic Concentrating Sieve or Magnetic Funnel

It is well known in the art of particle accelerator designs that multipole magnets can be used to focus a charged high energy particle beam. A typical arrangement includes a quadrupole or sextupole configuration. In the quadrupole (or by analogy in the sextupole) we can consider the situation as if four bar magnets are arranged like spokes pointing outward from around a central circle that is left open. The magnets pointing right and left are each positioned so that their south pole is close to the center of the ring and their north pole is pointed outward along a radius of the central circle. The magnets pointing up and down are positioned so that their north pole is close to the center of the ring and their south pole is pointed outwards along a radius of the central circle.

Focusing on the resulting magnetic field lines at the central circle, an interesting phenomenon is observed. A magnetic field line emerging downward from the north pole of the upper magnet curves into the south pole of the right or left magnet. Similarly, a magnetic field line emerging towards the central circle from the north pole of the bottom magnet also tends to curve in the south pole of the right or left magnet. The result is no magnetic field lines at all in the center of the central circle.

In a particle accelerator, a beam passing through a quadrupole magnet array is broadened slightly in a south-south plane and narrowed to a greater extent in the north-north plane. When the beam passes through a second quadrupole magnet array oriented at 90 degrees to the previous set, then an overall focusing is achieved. An improved effect occurs with a series of sextupole or octupole magnet arrays. Yet another alternative is a Halbach array in which the magnet field shape is manipulated by groupings of differently oriented sub-fields. This includes a cylindrical magnet with field lines limited to the interior of the cylinder.

In the current invention, a modified use of the magnetic focusing is accomplished in order to increase the efficiency of collision annihilation production. Under an electrostatic field, the positrons are accelerated towards a central electrode in the annihilation rope structure depicted in FIG. 7, while high energy electron emissions (β⁻ particles) are driven away from the central electrode with negative potential. The positrons accelerated inwards are intended to collide with the electrons driven outward with these annihilations taking place in an annihilation layer. Photons emerging from the annihilation later are deployed in the Compton layer to generate electricity or for pair production, but the rate of production of high energy collisions in the annihilation layer is critical to the efficient functioning of the system.

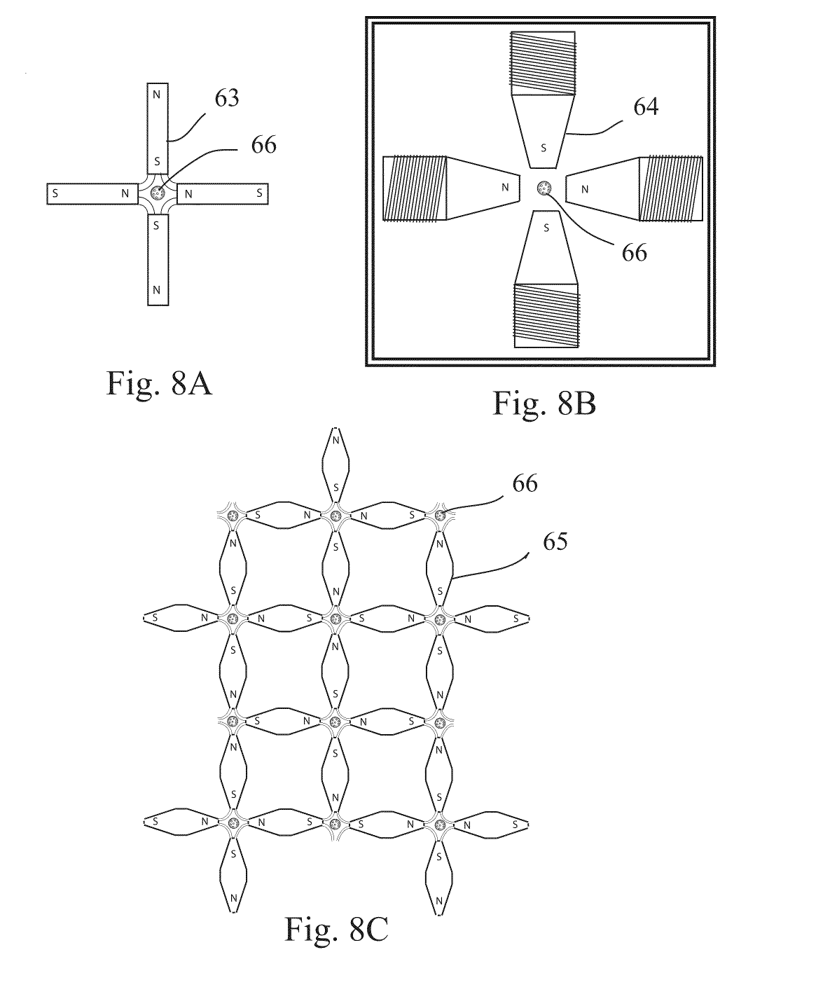

For this purpose a complex magnetic sieve is cast is gel form. FIG. 8 shows a comparison of a demonstrative bar magnet configuration 63 (FIG. 8A), a quadrupole magnet of a type used for a high energy particle accelerator with electric windings on each of the four electromagnets in the set 64 (FIG. 8B) and the magnetic sieve 65 for collision efficiency optimization in the annihilation rope (FIG. 8C). The sieve depicted in FIG. 8C can be formed in a layer with subsequent layers having polarity of the magnet regions rotated 90 degrees, but aligned with regard to the position of the site for the lepton beams. All of these configurations concentrate the moving electrons and positrons 66 so that collision likelihood is increased.

The shape of the magnet compartments in FIG. 8C are structured along a progressive angle on more superficial layers so that they tend to collect and beam the positrons and electrons. The alternate layers can also be oriented at 45 degrees to the layers above and below so that magnet regions occur in the zones that appear to be empty in FIG. 8C and thereby also contribute to the beaming and focusing.

To make these sheets, a layer is poured with unpolymerized gel and a displacement mold is placed on the upper surface of the gel. The gel is then polymerized and the displacement mold removed. Superparamagnetic nanoparticles suspended in unpolymerized gel are then poured into the empty spaces in the gel base left by the displacement mold. After the superparamagnetic nanoparticle unpolymerized gel is poured, it too is polymerized. The result is a layer with a complex pattern of superparamagnetic material is created. A sealing layer of additional gel or polymer such as polyacrylamide or cyanoacrylate can then be poured as well. These finished sheets may be stacked or wrapped into a rope layer.

Of note, a characteristic of a superparamagnetic material is that a strong magnetic field applied to one end can cause progressive dipole settling. Instead of connecting the magnet segments simply with magnetic field lines, there are actual thin channels connecting the segments as shown in FIG. 8C. These channels help conduct the magnetization through the material. Inclusion of solenoid coils around the margin of ends of the magnetic channels at the rope ends makes it possible to activate the magnetic field that propagates through the sieve and magnetizes it, thus enabling the magnetic lens function.

In another arrangement for progressively concentrating emitted positrons and electrons, the magnets or magnet areas are shorter and the beam opening larger in the layers further from the focal reaction volume. From another perspective the sieve can be fabricated with printed circuit technology to etch a mold by laser, fill with a suspension of the ceramic superparamagnetic nanoparticles, establish field orientation, then bake to remove water and heat liable molecules such as dextran, then seal. In this fashion fine grids of static magnetic field shaped structures can be synthesized.

The resulting energy budget of the device is based on the fact that in a chain reaction, pair production—the minimum energetic cost of sustaining the chain reaction is capped at the threshold of 1.022 MeV per event. To the extent that photons resulting from an annihilation carry energy in excess of this amount, there will be a net yield of energy. If this additional energy is greater than the energy needed to maintain the static electric field that accelerates the electrons and photons then there will be net energy production. To the extent that angular moment arising from interaction with the concentrating magnets adds to the kinetic energy, this will be an additional energy source.

A critical consideration in the energy budget is in the difference between maintaining a voltage to drive current in a circuit versus maintaining a voltage to support an electric field where there is no flowing current. The high voltage electrodes that accelerate the charged particle will only need sufficient input to maintain the field. In a more typical situation, electrons leave the surface of a material near the voltage source and travel through vacuum or medium to reach the electrode positive electrode. However firstly, there can be an insulation layer that impedes this current flow. More important in this situation, the same positive voltage attracts electrons and drives away positrons. When annihilation occurs above rest energy, the kinetic energy applied by the field to the leptons becomes photonic frequency encoding. The photon does not participate in the electric circuit. Rather, it travels to a different region of the device where it can add energy to electrons that are in a different low voltage circuit that yields the electric current that is the useful output of the device.

It is habitual to think of electric fields as requiring energy for their maintenance because this so often the way we encounter them. However, it may be more helpful to consider a gravitational field. Gravitation can apply considerable force on a continual basis, but there doesn't appear to be any requirement to add any energy to the earth to account for the work done by gravity. Consider a hydroelectric dam. The electric potential is arising from use of the gravitational field to pull the water down a chute, turn a wheel carrying a magnet, and then harvest the movement by producing a current. Here, a static gravitational field requiring no apparent input, can produce large amounts of electricity, without any of the energy that supports the existence of the gravitational field being consumed.

When an electric field is used to drive matter-antimatter reactions, the link between the input to maintain the voltage and the useful output of electricity is disconnected. The electric field is just creating the condition to maintain the annihilation reaction.

The volumes into which the source fluid is passed can also be shaped to tend to generate a focused collection—beam-like in structure—rather than a continuous sheet of source material whose output must then be focused.

In an alternate design, the positrons are produced in a thin sheet of tubular material adjacent to a vacuum. Positrons enter the interior of the long cylinder with low kinetic energy, but forming a positron cloud of increasing density. A high energy electron beam is formed by a field effect emission with high field acceleration as in a standard electron gun, but the beam is directed down the central axis of the long thin positron release cylinder containing the positron cloud. Here, the collision rate is optimized by forming a high energy focused electron beam from more conventional technology and then directing the beam into a positron cloud. The electron beam effectively passes perpendicular to the direction of movement of the positrons. Where a high density electron beam is adjusted so that its diameter is close to the diameter of the positron generation cylinder, a most efficient method of causing electron-positron collisions results wherein there is high kinetic energy introduced, but no need to have two opposing beams (one a positron beam and the other an electron beam) directly colliding with each other.

The electricity from an annihilation system such as shown in FIG. 7 can be used for various purposes including for instance a jet engine in which this electricity is used to drive the compressor fan in the engine so that the energy deriving from the combustion stage can be used entirely for propulsion without the need to divert a large portion of the combustion energy to driving the compressor fan. Similarly the annihilation device can provide a compact long duration source of electricity for standard designs of electric category rocket engines such as ion drive engines, Hall thrusters, magnetoplasmadynamic engines and other such engines well known to those skilled in the art of electric rocket engines.

What is claimed is:

1. A device for positron derived electricity comprising
a) means for generating positrons
b) means for providing matter anti-matter annihilations in materials capable of producing electricity by photovoltaic effects
c) means for capturing photovoltaic effects from high energy annihilation photons by providing materials comprising
i. a high-Z nano-particulate material capable of photovoltaic response in which an electron is displaced from a valence shell into a conduction band incorporated into
ii. a conductive material capable of delivering electric charge to an electrode.

2. A device for positron derived electricity comprising
a) means for generating positrons
b) means for providing matter anti-matter annihilations in materials capable of producing electricity by photovoltaic effects
c) means for capturing photoelectric effects from high energy annihilation photons by providing materials comprising
i. a high-Z nano-particulate material capable of photoelectric response in which an electron is displaced from a valence shell into a conduction band incorporated into
ii. a material for encountering re-emitted Compton effect photons to produce additional photovoltaic effects such as introduction of additional electrons into a conduction band
iii. a conductive material capable of delivering electric charge to an electrode

3. A device for positron derived electricity comprising
a) means for generating positrons
b) means for providing matter anti-matter annihilations in materials capable of producing electricity by photovoltaic effects
c) means for causing positron electron annihilation to occur near the site of nuclear decay by causing the positron to
i. pass through high density material positioned around the emitter
ii. for the purpose of shortening the distance of travel before annihilation
d) means for capturing photoelectric effects from high energy annihilation photons by providing materials comprising
i. a high-Z nano-particulate material capable of photoelectric response in which an electron is displaced from a valence shell into a conduction band incorporated into
ii. a material for encountering re-emitted Compton effect photons to produce additional photovoltaic effects such as introduction of additional electrons into a conduction band
iii. a conductive material capable of delivering electric charge to an electrode

4. The devices of claim 1, 2, or 3 wherein there is provided
a) means for removing the fluid containing the positron emitters from the device
b) means for restoring the fluid containing the positron emitters into the device.

5. The devices of claim 1, 2, 3, or 4, wherein there is provided
a) means for separately removing the fluid containing the photoelectric materials from the device
b) means for separately restoring the fluid containing the photoelectric materials into the device.

6. The devices of claim 1, 2, 3, 4, or 5 wherein there is provided
a) means for causing a change from the fluid state in the fluid medium
b) the change being accomplished by a method from among the group including at least: polymerization, polymerization by a catalyst, heating, cooling, gelation, hydration, dehydration, electrification, magnetization.

7. A method of storing electricity by generating positrons that comprises:
a) using solar cells to obtain electricity from solar energy;
b) using the electricity from the solar cells to activate a magnet pair in a cyclotron;
c) using additional electricity from the solar cells to operate radiofrequency amplifiers of the cyclotron;
d) introducing atomic nuclei selected from the group including hydrogen nuclei, helium nuclei, ³He, ⁴He into the cyclotron;
e) operating the cyclotron to direct a beam of such a nucleus into a metal foil made from a member of a group consisting of at least iron, chromium, nickel, manganese, vanadium, copper and any other metals capable of transformation into positron emitting metals under these conditions;
f) purifying ⁵²Mn by application and then removal of hydrochloric or sulfuric acid;
g) incorporating ⁵²Mn into spinel ferrite nanoparticles using means for precipitating soluble ferrite nanoparticles with a hydrophilic coating;
h) mixing the positron emitting spinel nanoparticles in an electrolyte solution containing a high density of crystal particles from the group of ferrite spinel, lanthanide/actinide garnet, lead-type garnet
i) optionally incorporating gel monomers into the electrolyte with the moderating and emitting nanoparticles
j) pouring the mixture into vessels provided with numerous semiconductor p-n junction collector units configured as photovoltaic cells wherein each of said photovoltaic cells is connected by an insulated conducting wire to a central insulated conducting cable
h) connecting the cable to a circuit bearing a resistive load.

8. The method of claim 7 wherein the resistive load is a conventional battery fitted into a battery charging circuit.

9. The method of claim 7 wherein the resistive load is used to heat a heating element.

10. A method of using electricity delivered by a positron containing medium that comprises
a) using solar cells to obtain electricity from solar energy;
b) using the electricity from the solar cells to activate a magnet pair in a cyclotron;
c) using additional electricity from the solar cells to operate radiofrequency amplifiers of the cyclotron;
d) introducing atomic nuclei selected from the group including hydrogen nuclei, helium nuclei, ³He, ⁴He into the cyclotron;
e) operating the cyclotron to direct a beam of such a nucleus into a metal foil made from a member of a group consisting of at least iron, chromium, nickel, manganese, vanadium, copper and any other metals capable of transformation into positron emitting metals under these conditions;
f) purifying ⁵²Mn by application and then removal of hydrochloric or sulfuric acid;
g) incorporating ⁵²Mn into spinel ferrite nanoparticles using means for precipitating soluble ferrite nanoparticles with a hydrophilic coating;
h) mixing the positron emitting spinel nanoparticles in an electrolyte solution containing a high density of crystal particles from the group of ferrite spinel, lanthanide/actinide garnet, lead-type garnet
i) optionally incorporating gel monomers into the electrolyte with the moderating and emitting nanoparticles
j) pouring the mixture into vessels provided with numerous semiconductor p-n junction collector units configured as photovoltaic cells wherein each of said photovoltaic cells is connected to a circuit comprising a loop coil and a microprocessor unit, wherein the microprocessor unit obtains inputs reporting to it the orientation and relative position of the assembly
i. the unit being capable of continuously transmitting digital information describing its position and orientation within the vessel;
ii. the unit being capable of receiving control signals;
iii. the unit being capable of adjusting current flow through the loop coil in order to magnetize or demagnetize a ferrofluid containing dissolved/suspended superparamagnetic ferrite nanoparticles; and,
iv. the loop coil surrounding a piston and piston block;
v. the unit being capable of driving the buoyant piston out of the block when the fluid within in the piston block is magnetized;
vi. the pistons being connected to force delivery fibers
vii. the fibers being configured into networks for applying force to the vessel walls and skeleton for the purpose of moving the walls and skeleton of the vessel

11. A method of using electricity delivered by a positron containing medium that comprises
a) using solar cells to obtain electricity from solar energy;
b) using the electricity from the solar cells to activate a magnet pair in a cyclotron;
c) using additional electricity from the solar cells to operate radiofrequency amplifiers of the cyclotron;
d) introducing atomic nuclei selected from the group including hydrogen nuclei, helium nuclei, ³He, ⁴He into the cyclotron;
e) operating the cyclotron to direct a beam of such a nucleus into a metal foil made from a member of a group consisting of at least iron, chromium, nickel, manganese, vanadium, copper and any other metals capable of transformation into positron emitting metals under these conditions;
f) purifying ⁵²Mn by application and then removal of hydrochloric or sulfuric acid;
g) incorporating ⁵²Mn into spinel ferrite nanoparticles using means for precipitating soluble ferrite nanoparticles with a hydrophilic coating;
h) mixing the positron emitting spinel nanoparticles in an electrolyte solution containing a high density of crystal particles from the group of ferrite spinel, lanthanide/actinide garnet, lead-type garnet
i) optionally incorporating gel monomers into the electrolyte with the moderating and emitting nanoparticles
j) pouring the mixture into vessels provided with numerous semiconductor p-n junction collector units configured as photovoltaic cells wherein each of said photovoltaic cells is connected to a circuit comprising a loop coil and a microprocessor unit, wherein the microprocessor unit obtains inputs reporting to it the orientation and relative position of the assembly
i. the unit being capable of continuously transmitting digital information describing its position and orientation within the vessel;
ii. the unit being capable of receiving control signals;
iii. the unit being capable of adjusting current flow through the loop coil in order to magnetize or demagnetize a ferrofluid containing dissolved/suspended superparamagnetic ferrite nanoparticles; and,
iv. the loop coil surrounding a piston and piston block;
v. the unit being capable of driving the buoyant piston from an outer chamber of the block surrounded by the coil into an inner chamber not surrounded by the coil when the fluid within the outer portion of the piston block is magnetized;
vi. the pistons being connected to force delivery traction fibers
vii. the fibers being configured into networks for applying contraction force to the vessel walls, internal sub-units and skeleton for the purpose of moving the walls and skeleton of the vessel

12. The methods of claim 8, 9, 10, or 11 wherein a superconducting magnet is used at step b) to minimize the required electrical input to operate the cyclotron.

13. The methods of claim 7, 8, 9, 10, 11, or 12 wherein any useful positron emitting isotope of any element is used in place of ⁵²Mn.

14. The methods of claim 13 wherein the element used is a metal.

15. An internal annihilation engine comprising
a) an electric current based method for magnetizing a superparamagnetic positronic fluid
i) including the use of a coil around a piston block
ii) conductors passing through a switching mechanism capable of alternately applying current to the coil to create a magnetic field within the piston chamber
b) means for obtaining electric power from photovoltaic effects of
i) a positronic fluid carrying dissolved nanoparticles or chelation molecules incorporating positron emitting nuclides
ii) a conducting fluid capable of conducting electrons that are elevated to increased energy by impact of annihilation and gamma photons so that they are ejected from valence orbitals
iii) an externally applied voltage or directional electric field optionally provided from a positively charged insulated device activated by electron depletion or optionally from a battery or optionally from an externally applied electric current
c) a connection for applying a positronically derived electric current to a coil
i) a conductor providing a circuit from one pole of the fluid conductive photovoltaic material inside an insulating outer lining
ii) said conductor reaching one end of the coil around the piston chamber
iii) said conductor then extending from the other end of the coil and reaching the opposite electric pole of the photovoltaic chamber from which it originates
d) sensors for monitoring and controlling the magnetization
i) a magnetometer associated with each piston chamber associated with
ii) microelectronics capable of communicating with a central processor that is either a general purpose computer with an algorithm that monitors the degree of magnetization and timing of magnetization and can control the flow of current according to the degree of magnetization required for engine operation
iii) the information being conducted optionally by an optical fiber system to minimize effects of electromagnetic noise
e) a superparamagnetic fluid for using the magnetization to drive a piston
i) a piston of density higher than the liquid medium in which the superparamagnetic nanoparticles are dissolved
ii) which piston is ejected from the fluid in the piston chamber when the superparamagnetic fluid is magnetized
f) a mechanical connection of the piston or pistons to a drive shaft
i) fitting the piston rod to a cam type driveshaft in the arrangement typically used with internal combustion engines

16. An external annihilation assisted jet engine of high fuel efficiency comprising
a) means for obtaining electric power from photovoltaic effects of
i) a positronic fluid carrying dissolved nanoparticles or chelation molecules incorporating positron emitting nuclides
ii) a conducting fluid capable of conducting electrons that are elevated to increased energy by impact of annihilation and gamma photons so that they are ejected from valence orbitals
iii) an externally applied voltage or directional electric field optionally provided from a positively charged insulated device activated by electron depletion or optionally from a battery or optionally from an externally applied electric current
b) connection for applying a positronically derived electric current to a direct current motor
i) a conductor providing a circuit from one pole of the fluid conductive photovoltaic material inside an insulating outer lining
ii) said conductor reaching one input of the direct current motor
iii) said conductor then extending from the exiting current pole of the motor
c) sensors for monitoring and controlling the current and voltage applied and monitoring
d) mechanical or optionally geared or optionally incorporating pulley arrangements to connect the drive shaft to the fan compressor of a jet engine
e) using the compressed air to mix with combustion fuel such as standard aviation hydrocarbon fuel
i) using the combustion products to provide the exhaust that created propulsion
ii) deploying all of the energy deriving from combustion for the exhaust
iii) using only photovoltaic energy for the compressor

17. An external annihilation rocket engine comprising
a) means for obtaining electric power from photovoltaic effects of
i) a positronic fluid carrying dissolved nanoparticles or chelation molecules incorporating positron emitting nuclides
ii) a conducting fluid capable of conducting electrons that are elevated to increased energy by impact of annihilation and gamma photons so that they are ejected from valence orbitals
iii) an externally applied voltage or directional electric field optionally provided from a positively charged insulated device activated by electron depletion or optionally from a battery or optionally from an externally applied electric current
b) connection for applying a positronically derived electric current to an electric rocket engine from among the group of an ion drive engine, a Hall thruster or a magnetoplasmadynamic thruster
i) a conductor providing a circuit from one pole of the fluid conductive photovoltaic material inside an insulating outer lining
ii) said conductor reaching one input of the plasma type electric rocket engine's electric system
iii) said conductor then extending from the exiting current pole of the electric rocket engine
c) means for a positron production chain reaction process to provide continuing high efficiency production of electric current for operating the rocket engine

18. An internal annihilation plasma engine comprising
a) means for obtaining electric power from photovoltaic effects of
i) a positronic fluid carrying dissolved nanoparticles or chelation molecules incorporating positron emitting nuclides
ii) a conducting fluid capable of conducting electrons that are elevated to increased energy by impact of annihilation and gamma photons so that they are ejected from valence orbitals
iii) an externally applied voltage or directional electric field optionally provided from a positively charged insulated device activated by electron depletion or optionally from a battery or optionally from an externally applied electric current
b) connection for applying a positronically derived electric current to a gas ionization system
i) a conductor providing a circuit from one pole of the fluid conductive photovoltaic material inside an insulating outer lining
ii) said conductor reaching one input of the electric system of a group including at least a plasma type electric jet engine and a plasma type rocket engine
iii) said conductor then extending from the exiting current pole of the engines electric system
c) means optionally provided for a positron production chain reaction process to provide continuing high efficiency production of electric current for operating the electric portion of the engine
d) a positron production chain reaction process to provide continuing bombardment of positrons into a chamber progressively filled with a gas from a group including at least noble gases such as argon
i) electron depletion of the gas to produce a mass of positively charged gas ions
ii) a lining of the chamber at all sides except the nozzle wherein the lining contains insulated positively charged electron depleted material that was generated by prior positron bombardment
e) expulsion of the ionized gas through the exhaust nozzle due to repulsion from the other gas atoms and from the surrounding electric field
d) use of the force of repulsion expelling the gas in order to obtain forward thrust

19. A method of generating annihilation photons comprising
a) applying a voltage to a material emitting positrons wherein
b) the voltage accelerates and adds energy to the positrons
c) applying a voltage to electrons adding energy to the electrons
d) using a structure in which the directionality of the accelerations of the positrons and electrons occurs in a way such that an annihilation takes place with more than the rest energy of electrons and positrons so that
e) the resulting photons have energy greater than the 511 keV rest energy
f) positioning and directing said elevated-energy annihilation photons so that they cause pair production of both an electron and a positron
g) establishment of conditions in which the pair production participates in chain reaction production of additional positrons as distinct from a process in which all that occurs is that supplied positrons are consumed as their energy is harvested.
h) establishment of conditions in which positrons produced by high energy photons can produce products that can themselves lead to the production of additional positrons

20. The method of claim 19 in which a sustainable controllable matter-antimatter chain reaction is accomplished wherein
a) electrons are harvested yielding energy in excess of what is required to support the chain reaction
b) the original positron containing fuel acting analogous to “kindling” for fire wherein
c) the chain reaction then progresses to cause more electron-positron annihilations, consuming materials provided in the reaction system

21. A device for causing collisions between positrons and electrons comprising
a) a source material incorporating nuclides that emit electrons
b) a source material incorporating nuclides that emit positrons
c) an electrode for creating an electrical field that accelerates the positrons and electrons towards each other
d) an array of magnets or magnetic areas that concentrate the positrons by
i. positioning the north end of two separate magnets or magnet areas near each other with a space between them to allow particles to pass and
ii. a second pair of magnets in which the south poles are also positioned near each other but between the first two, so that
iii. the four magnets form a series of spokes of alternating magnetic polarity
e) wherein the resulting magnetic quadrupole structure is repeated two or a plurality of times in a layer so that the layer has multiple openings for passage of concentrated electrons and positrons

22. The device of claim 21 wherein there are multiple layers each of which layers contains multiple magnetic quadrupoles
a) where the layers are so aligned that an electron or positron passes sequentially through the beam opening of one layer after another
b) where the orientation of the magnetic polarities is rotated ninety degrees

23. The devices of claims 21 and 22 wherein six magnets or magnet areas are arrayed with alternating polarities in a sextupole structure

24. The devices of claims 21 and 22 wherein eight or more magnets or magnet areas are arrayed with alternating polarities in an octupole or greater structure

25. The devices of claims 21 to 24 where in additional magnets or magnet areas are positioned to funnel electrons and positrons towards the passage areas at the center of each quadrupole, sextupole, octupole or greater array.

26. The devices of claims 21 to 25 wherein the magnets or magnet areas are comprises of superparamagnetic nanoparticles immobilized in a gel.

27. An annihilator electrical component that creates electric currents and electric streams as component parts of an electrical circuit comprising
a) a central rod
i) through containing a positron emitting and electrically conducting material
ii) an output conductor extending from a point of contact with the conducting material
iii) a low density insulating outer lining
b) an external cylinder placed around the rod but separated from it by the insulation
i) the cylinder being composed of a conductive material preferably of metallic type
ii) an input conductor connected to the central rod
iii) an insulation including low density material on its inner lining but containing high density material on its outer lining in order to provide shielding against photons and positrons that may tend to exit the device's outer surface
c) introduction of a replaceable supply of positron emitting fluid and electrically conducting fluid so that
i) as positrons are emitted from the rod they will enter the surrounding cylinder and undergo annihilations that will deplete the outer cylinder of electrons
ii) as positrons are emitted and protons changed to neutrons in the rod, the resulting excess electrons will be available to flow out of the rod through the conductor, across components from the group of at least a load, a thyristor, a switch, a capacitor, a resistor, motor, an incandescent light filament, a current flow sensor, a discharged battery and then
iii) said electrons will then flow into the electron depleted cylinder to replace the annihilated electrons

28. Use of the device of claim 27 to generate a static electric field wherein the flow of electrons is prevented by opening of the circuit at the switch

29. Use of the device of claim 27 to generate electric current using matter-antimatter annihilations wherein the amperage is determined by the specific activity and the half life of the emitter used

30. Use of the device of claim 27 to generate electric voltage using matter-antimatter annihilations wherein the voltage is determined by the degree to which a mismatch between the depletion of electrons and the resupply of electrons is allowed to develop by impeding or diverting their flow between the rod and the cylinder of the annihilator

31. The method of claim 30 where the process of positron emission and subsequent annihilation is used to destroy and remove electrons from an electron depletion electrode.

32. The method of claim 31 where the process of β⁻ emission is used an electron source in an electron accumulation electrode in place of the positron source.

33. method of claim 31 and claim 32 where the depletion and accumulation electrodes are
i) kept separate and isolated from each other for the purpose of generating a high potential difference.
ii) connected to each other by a conductor or semiconductor along with a load for the purpose of providing a current to do work by the use of electric current.

34. method of claim 33 where a thyristor, diode or other directional control circuit element is used to avoid effects of difference in flow from leakage or from differences in half-life or field emission effects or electron absorption effects.

35. The methods and devices of claims 27 through 34 where a replacement element or inflow of replaceable source material such as ferrite nanoparticles or chelation molecules carrying a positron emitter or β⁻ emitter is used to refresh the emission source as half-life decay progresses.

36. The use of said annihilator circuit element to provide a high potential electric field for the purpose of adding kinetic energy to electrons and positrons prior to annihilation wherein the resulting high energy photons can cause pair production of further positrons.

37. The methods and devices of claims 27 through 36 wherein the annihilator or creator element is used in an electric stream or circuit that is deployed to recharge a conventional battery.

38. A cyclotron system in which the voltage in each Dee of the cyclotron arises from an annihilator or creator component.

39. A method for providing a stable electric field comprising
a) casting a low density low conductivity coating of polycarbonate to completely surround a conducting material incorporating metallic crystalline material
b) placing a charging chamber adjacent to said insulated material
c) passing a material into the charging chamber that includes a nuclide emitting positrons wherein
i) said charging chamber is so positioned that positrons emitted therein will travel from the charging chamber into the conducting material
ii) thereby losing their kinetic energy within the conducting material so that
iii) the positrons become subject to electrostatic forces and
iv) therein undergo collision with an electron resulting in an annihilation that
v) depletes the number of electrons in the conducting material by one
d) replacing the contents of the charging chamber so that a sustained intensity of positron bombardment of the insulated conductor is provided
e) the material in the charging chamber including a mixture of positron emitting material from the group of solids, liquids or gasses, intermingled with a
f) second material that first undergoes electron depletion by
i) β⁻ emission in which electrons are ejected by the kinetic energy of nuclear disintegration so that they exit the material
ii) are captured on cathode subject to an electromotive voltage and sink so that said electrons flow away from said β⁻ emission material
iii) with such depletion continuing until a large positive charge accumulates in said second material
g) mixing the electron depleted second material with the positron emitting material
h) introducing this mixture into proximity with the insulation surrounded conductor
i) allow the mixture that is initially positively charged to gradually become neutral as positrons are emitted and travel into the insulation surrounded conductor
j) then withdraw the charging chamber from proximity with the insulated conductor.

39. The method of claim 38 wherein the nuclide used for the positron emission is ⁵²Mn.

40. The method of claim 38 or 39 wherein the β⁻ emitter is ⁹⁹Mo or ⁵⁹Fe.

41. The method of claim 38, 39 or 40 wherein the insulation coated conductor is in the shape of a disk with an empty center with the conductor thus forming a ring or cylindrical tube surrounded on all surfaces by a thickness of the insulator.

42. The method of claim 41 wherein the thickness of the insulator is between 0.2 cm and 1.5 cm but preferably 1 centimeter

43. The method of claim 42 wherein the charging chamber is in the form of a cylinder with a diameter capable of fitting into the central cavity of the device of claim 41.

44. The method of claim 43 wherein the charging chamber has a central space maintained with a vacuum and the charging substance is within an enclosed layer in the outer surface of the cylinder.

45. The method of claim 44 wherein the charging substance is a liquid carrying nanoparticles that contain the positron emitting nuclide.

46. The method of claim 44 wherein the charging substance is a liquid carrying chelated atoms of the positron emitting nuclide.

47. A device for providing a stable electric field comprising a
a) a low density low conductivity coating of polycarbonate cast to completely surround a conducting material incorporating metallic crystalline material
b) a charging chamber adjacent to said insulated material
c) a material passed into the charging chamber that includes a nuclide emitting positrons wherein
i) said charging chamber is so positioned that positrons emitted therein will travel from the charging chamber into the conducting material
ii) thereby losing their kinetic energy within the conducting material so that
iii) the positrons become subject to electrostatic forces and
iv) therein undergo collision with an electron resulting in an annihilation that
v) depletes the number of electrons in the conducting material by one
d) the contents of the charging chamber being periodically replaceable so that a sustained intensity of positron bombardment of the insulated conductor is provided
e) the material in the charging chamber including a mixture of positron emitting material from the group of solids, liquids or gasses, intermingled with a
f) second material that first undergoes electron depletion by
i) β⁻ emission in which electrons are ejected by the kinetic energy of nuclear disintegration so that they exit the material
ii) are captured on cathode subject to an electromotive voltage and sink so that said electrons flow away from said β⁻ emission material
iii) with such depletion continuing until a large positive charge accumulates in said second material
g) the electron depleted second material having been mixed with the positron emitting material
h) the mixture being in proximity with the insulation surrounded conductor
i) the mixture that is initially positively charged to having been allowed to gradually become neutral as positrons are emitted and travel into the insulation surrounded conductor
j) wherein the charging chamber is withdrawn from proximity with the insulated conductor after the conductor is sufficiently depleted of electrons to achieve the desired positive electric charge.

48. The device of claim 47 wherein the nuclide used for the positron emission is ⁵²Mn.

49. The device of claim 47 or 48 wherein the β⁻ emitter is ⁹⁹Mo or ⁵⁹Fe.

50. The device of claim 47, 48 or 49 wherein the insulation coated conductor is in the shape of a disk with an empty center with the conductor thus forming a ring or cylindrical tube surrounded on all surfaces by a thickness of the insulator.

51. The device of claim 50 wherein the thickness of the insulator is between 0.2 cm and 1.5 cm but preferably 1 centimeter

52. The device of claim 51 wherein the charging chamber is in the form of a cylinder with a diameter capable of fitting into the central cavity of the device of claim 41.

53. The device of claim 52 wherein the charging chamber has a central space maintained with a vacuum and the charging substance is within an enclosed layer in the outer surface of the cylinder.

54. The device of claim 53 wherein the charging substance is a liquid carrying nanoparticles that contain the positron emitting nuclide.

55. The device of claim 53 wherein the charging substance is a liquid carrying chelated atoms of the positron emitting nuclide.

56. A device capable of producing continuous fluorescent light with no electrical circuit input comprising
a) a device of claims 47 to 55 placed in proximity to a chamber containing
i) a gas subject to ionization and
ii) a gas subject to photon emission
b) a coating of the interior of the glass capable of fluorescing
c) a grid of conducting material capable of accumulating electrons near the insulated conductor that holds the static positive charge and
i) conducting such accumulating electrons to a distant cathode at the opposite pole of the fluorescent light tube from which electrons are being emitted in response to the attraction of the ionized gas and the positive electric field
ii) mercury vapor whose atoms are subject to emitting photons in response to impacts by electrons

57. A device capable of charging a battery comprising
a) a device of claims 47 to 55 placed in proximity to a battery from among the group of at least lead acid, alkaline manganese dioxide, nickel cadmium, nickel metal hydride, nickel zinc, lithium ion polymer, lithium titanate, silver oxide or any other battery that is a secondary cell class susceptible to being recharged by the application of an externally applied electric field,
b) a current path between the electrodes or through the electrolyte that allows positive ions to be forced into the positive region by repulsion from an applied external positive electric field and electrons to be forced into the negative region by attraction to the applied external positive electric field.

58. The device of claim 57 comprising additionally at least one method of monitoring the rate of progress of the recharging process from among the group a voltage monitoring circuit, a temperature detector, a rate of charging monitoring circuit.

58. A device capable of causing levitation comprising
a) a series of devices of claims 47 to 55 placed in fixed relation to the ground in succession along a rail
b) a set of devices of claims 47 to 55 placed in fixed relation to the undercarriage of a movable structure capable of carrying freight or persons wherein
i) said undercarriage mounted positive charge devices are positioned so as to interact and be repelled by the positive charge devices within the rail
ii) optionally with a chamber capable of maintaining a moving seal inside which a vacuum can be maintained
iii) resulting in a levitation of the movable structure
c) a second set of positive charge devices mounted in the undercarriage of the movable structure positioned in contact with said chamber but of greater field strength than the first set of positive charge devices for the purpose of scavenging stray electrons that enter the chamber
i) fitted with an electron collection grid on the face of the device exposed in the chamber
ii) wherein the grid is connected to conductor leading to the a surface of the that device that is not exposed in the chamber
iii) wherein the not exposed surface has an electron accumulation area placed at a greater proximity to the positive charge interior than the proximity of the collecting grid
iv) wherein this second set of positive charge devices is capable of being rotated into a position where the accumulated electrons will be attracted to both the rail and the undercarriage positive charge devices to effect a braking effect that inhibits motion
v) wherein the this second set of positive charge devices is also capable of being rotated into a position where the positive charge is exposed to the portion of the rail just behind the movable structure in order to provide repulsion that accomplishes a forward motion

59. The device of claim 58 wherein the devices fixed to the ground are in a group of surface types including at least a floor, a ramp or a road rather than in a rail.

60. A device capable of desalinating sea water comprised of
a) an series of insulated positively charged devices of claims 47 to 55 placed in physical proximity to one side of a square pipe between two inches and ten feet in diameter but preferably four to six inches in cross section or in which flowing sea water passes continuously wherein
b) positively charged ions are driven towards the opposite wall of the pipe and negatively charged ions are driven toward the side of the pipe containing the stable static positively charged devices
c) the pipe is fitted with a series of baffles tending to impede the flow of water near the peripheral areas of the pipe but not impede the flow of water in the central areas
d) water is extracted after passage down a prolonged series of these ion separation regions wherein the emerging water has less salt than the water introduced and the longer the series the lower the resulting salt content
e) said system being recharged by allowing sea water to flow down the pipe in a reverse direction
f) optionally accelerating the recharging process withdrawing the charged devices from the immediate proximity of the pipe

61. The device of claim 60 in which pipe of any cross sectional shape is used
